(19) United States
(12) Patent Application Publication
(10) Pub. No.: US 2006/0139715 A1
(43) Pub. Date: Jun. 29, 2006

(54) Optical scanning device and image forming apparatus

(75) Inventors: Yasuo Tamaru, Aichi-ken (JP); Ryota Kato, Aichi-ken (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: Brother Kogyo Kabushiki Kaisha, Nagoya-shi (JP)

(21) Appl. No.: 11/311,471

(22) Filed: Dec. 20, 2005

(30) Foreign Application Priority Data
Dec. 24, 2004 (JP) 2004-374371
Dec. 24, 2004 (JP) 2004-374373

(51) Int. Cl. G02B 26/08

(52) U.S. Cl. 359/204; 359/212; 347/243

(57) ABSTRACT

A first holder plate that holds a first laser emitting portion and that has a first insertion hole formed therein, a second holder plate that holds a second laser emitting portion and that has a second insertion hole formed therein, and a base plate that supports a first collimating lens and a second collimating lens and that has a first screwing hole and a second screwing hole formed therein, are continuously formed by a bending process. A slit plate having two slits bored therein which are disposed in parallel and in a sub scanning direction is provided between a reflecting mirror and a cylindrical lens. The reflecting mirror combines the optical paths of two laser beams emitted from the two laser emitting portions such that the optical paths are matched in a main scanning direction. The cylindrical lens allows the two laser beams to converge in the sub scanning direction.

### CROSS-REFERENCE TO RELATED APPLICATIONS

This Nonprovisional application claims priority under 35 U.S.C. § 119(a) on Patent Applications No. 2004-374371 filed in Japan on Dec. 24, 2004 and No. 2004-374373 filed in Japan on Dec. 24, 2004, the entire contents of which are hereby incorporated by reference.

### BACKGROUND

The present invention relates to an image forming apparatus, such as a laser printer, and an optical scanning device mounted on the image forming apparatus.

In an electrophotographic image forming apparatus such as a laser printer, an electrostatic latent image formed on a photosensitive drum is developed with toner to thereby form a toner image and the toner image is transferred onto a sheet of paper, whereby an image is formed. Such an image forming apparatus has mounted thereon an optical scanning device for forming an electrostatic latent image on the photosensitive drum. In the optical scanning device, a laser beam emitted from a laser diode is collimated by a collimating lens into a parallel pencil of rays, and the spread of the parallel pencil of rays is controlled through a slit. Thereafter, the parallel pencil of rays is converged in a sub scanning direction by a cylindrical lens and the converged rays are formed into an image on a high speed rotating polygon mirror. The pencil of rays reflected off the polygon mirror is then scanned in a main scanning direction and outputted, through various lenses and mirrors, toward the photosensitive drum from the optical scanning device.

In such an optical scanning device, if position alignment of the starting point of a pencil of rays, i.e., the laser diode, and the collimating lens is not done with high accuracy, a deviation of the optical path increases in the subsequent stages. In view of this, for example, a technique is proposed in which a laser diode is disposed at a point of action of a holding portion having a connecting portion as a fulcrum and an extended end portion as a point where force is applied, and by adjusting a screw at the point where force is applied a fine adjustment is made to the distance between the laser diode and a collimating lens (see Japanese Patent Application Laid-Open No. 2004-163463).

As an electrophotographic color laser printer, a tandem color laser printer is known in which are provided four photosensitive drums on which electrostatic latent images of various colors corresponding to yellow, magenta, cyan, and black are formed. In the tandem laser printer, toner images of the various colors are transferred from the respective photosensitive drums onto a sheet of paper which sequentially passes the photosensitive drums and thereby the colors are sequentially superposed. Thus, a color image can be formed at substantially the same speed as that for a monochrome laser printer.

In such a tandem color laser printer, since there is a need to form on the four photosensitive drums electrostatic latent images corresponding to the various colors, respectively, it is necessary to provide four optical scanning devices for the four photosensitive drums, respectively. However, the provision of four optical scanning devices inevitably increases costs and the size of the apparatus. In view of this, a technique is proposed in which laser beams emitted from four semiconductor lasers corresponding to various colors are combined in their optical paths in a main scanning direction by a plurality of half-mirrors, and then, the laser beams are allowed to enter the same single deflecting and reflecting surface of a single deflector at different angles in a sub scanning direction, and thereby deflection scanning in the main scanning direction and optical path separation in the sub scanning direction are done, whereby electrostatic latent images corresponding to the various colors are formed on four photosensitive drums using a single tandem scanning optical device (see Japanese Patent Application Laid-Open No. 2003-215487).

### SUMMARY

In a tandem color laser printer, since electrostatic latent images corresponding to various colors, respectively, are formed on four photosensitive drums, four laser diodes and four collimating lenses are required for the four photosensitive drums, respectively. This accordingly requires four holding portions, such as the one described in Japanese Patent Application Laid-Open No. 2004-163463 for position adjustably holding a laser diode and a collimating lens. However, the provision of such a holding portion for each laser diode and collimating lens makes the configuration of the apparatus complex and causes an increase in costs. In addition, in each holding portion, accurate position adjustment is required between the laser diode and the collimating lens.

In the tandem scanning optical device described in Japanese Patent Application Laid-Open No. 2003-215487, laser beams emitted from four semiconductor lasers are converted into parallel pencils of rays by a collimating optical system and the rays are combined in their optical paths in a main scanning direction by a plurality of mirrors, and thus, an error may occur in each laser beam in a sub scanning direction due to the processing accuracy of each mirror or the position accuracy of the collimating optical system. If such an error occurs, an error may occur in the incident angle to a deflecting and reflecting surface of a deflector, causing a problem that deflection scanning cannot be accurately performed by the deflector.

An object is to provide an optical scanning device with which a simplification of the configuration and a reduction in costs can be achieved by efficiently disposing a first laser emitting portion and a first lens, and a second laser emitting portion and a second lens, and in addition, position adjustment between the first laser emitting portion and the first lens and between the second laser emitting portion and the second lens can be easily made, and an image forming apparatus having such an optical scanning device.

Another object is to provide an optical scanning device with which accurate deflection and scanning of a plurality of laser beams can be ensured by allowing laser beams emitted from a plurality of laser emitting portions to accurately enter, in a sub scanning direction, a light deflecting unit, and an image forming apparatus having such an optical scanning device.

An optical scanning device according to a first aspect comprises: a first holding member including: a first holding portion that holds a first laser emitting portion that emits a first laser beam; and a first-screw inserting portion that allows a first screw to be inserted thereinto; a second holding member including: a second holding portion that holds a second laser emitting portion that emits a second laser beam; and a second-screw inserting portion that allows a second screw to be inserted thereinto; a base member including: a first-lens supporting portion that supports a first lens through which the first laser beam passes; a second-lens supporting portion that supports a second lens through which the second laser beam passes; a first-screw inserting and fixing portion that allows the first screw inserted into the first-screw inserting portion to be inserted thereinto for fixation; and a second-screw inserting and fixing portion that allows the second screw inserted into the second-screw inserting portion to be inserted thereinto for fixation; and a light deflecting unit that deflects and scans the first laser beam and the second laser beam in a main scanning direction.

By allowing the first laser emitting portion to be held by the first holding portion provided to the first holding member, allowing the second laser emitting portion to be held by the second holding portion provided to the second holding member, and allowing the first lens and the second lens to be supported by the first-lens supporting portion and the second-lens supporting portion provided to the base member, respectively, the first laser emitting portion and the first lens and the second laser emitting portion and the second lens can be efficiently disposed, making it possible to simplify the configuration and to reduce costs. Moreover, by inserting the first screw into the first-screw inserting portion provided to the first holding member and then adjusting the position of the first screw with respect to the first-screw inserting and fixing portion provided to the base member and fixing the first screw, the relative position between the first holding member and the base member is adjusted, whereby the position of the first laser emitting portion can be adjusted with respect to the first lens. In addition, by inserting the second screw into the second-screw inserting portion provided to the second holding member and then adjusting the position of the second screw with respect to the second-screw inserting and fixing portion provided to the base member and fixing the second screw, the relative position between the second holding member and the base member is adjusted, whereby the position of the second laser emitting portion can be adjusted with respect to the second lens. Thus, position adjustment between the first laser emitting portion and the first lens and between the second laser emitting portion and the second lens can be easily made.

An optical scanning device according to a second aspect comprises: a plurality of laser emitting portions that emit laser beams; a light deflecting unit that deflects and scans, in a main scanning direction, the laser beams emitted from the laser emitting portions; an optical path combining unit disposed in a passing direction of a laser beam and between the laser emitting portions and the light deflecting unit, and allowing the laser beams emitted from the laser emitting portions to be matched in the main scanning direction; and a slit member disposed in the passing direction of a laser beam and between the optical path combining unit and the light deflecting unit, and having diaphragm apertures disposed therein in parallel and in a sub scanning direction, the diaphragm apertures being formed so as to correspond to the laser beams emitted from the laser emitting portions.

A plurality of laser beams that are matched in the main scanning direction by the optical path combining unit are then adjusted in their positions in the sub scanning direction by the diaphragm apertures of the slit member disposed in parallel and in the sub scanning direction, and thereafter, enter the light deflecting unit. Since the laser beams enter the light deflecting unit after error is reduced not only in the main scanning direction but also in the sub scanning direction, the laser beams can be accurately deflected and scanned by the light deflecting unit. Moreover, since diaphragm apertures that allow laser beams to pass therethrough are provided in the same single slit member, high relative position accuracy between laser beams is achieved, making it possible to ensure accurate relative position between laser beams that enter the light deflecting unit. Accordingly, accurate deflection and scanning can be ensured between laser beams.

The above and further objects and features of the invention will more fully be apparent from the following detailed description with accompanying drawings.

### BRIEF DESCRIPTION OF THE SEVERAL VIEWS OF THE DRAWINGS

FIG. 1 is side cross-sectional view of a color laser printer according to an embodiment, which serves as an image forming apparatus;

FIG. 2 is a plan view of a scanner unit (first embodiment) of the color laser printer shown in FIG. 1;

FIG. 3 is a perspective view of an optical system of laser irradiation optical portions in the scanner unit (first embodiment) shown in FIG. 2;

FIG. 4 is a perspective view of a position adjustment frame of the laser irradiation optical portions shown in FIG. 3;

FIG. 5 is a plan view of the position adjustment frame of the laser irradiation optical portions shown in FIG. 3;

FIG. 6 is a side view of an optical system of laser output optical portions in the scanner unit (first embodiment) shown in FIG. 2;

FIG. 7 is a side view of an optical system of laser irradiation optical portions in a scanner unit (second embodiment) of the color laser printer shown in FIG. 1;

FIG. 8 is a plan view of the optical system of the laser irradiation optical portions in the scanner unit (second embodiment) of the color laser printer shown in FIG. 1;

FIG. 9 is a perspective view of the optical system of the laser irradiation optical portions in the scanner unit (second embodiment) of the color laser printer shown in FIG. 1;

FIG. 10 is a perspective view for explaining positioning of a second slit plate in the laser irradiation optical portion shown in FIG. 9; and

FIG. 11 is a side view of an optical system of laser output optical portions in the scanner unit (second embodiment) of the color laser printer shown in FIG. 1.

### DETAILED DESCRIPTION OF THE EXEMPLARY EMBODIMENTS

### Overall Configuration of a Color Laser Printer

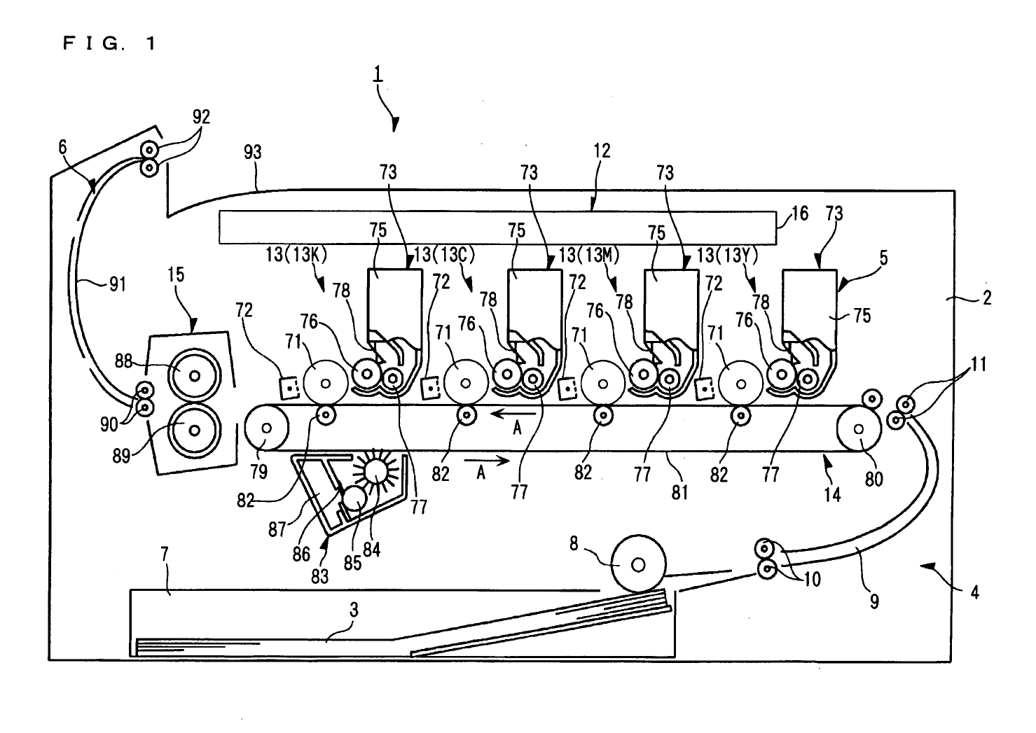

FIG. 1 is a side cross-sectional view of a color laser printer according to an embodiment, which serves as an image forming apparatus of the present invention. This color laser printer 1 is a horizontal tandem color laser printer in which a plurality of process portions 13 are disposed in parallel with one another in a horizontal direction. A box-shaped main body casing 2 of the color laser printer 1 includes therein a paper feeding portion 4 for feeding a sheet of paper 3; an image forming portion 5 for forming an image on the fed sheet of paper 3; and a paper ejecting portion 6 for ejecting the sheet of paper 3 having an image formed thereon.

### Configuration of the Paper Feeding Portion 4

The paper feeding portion 4 includes a paper cassette 7 provided at the bottom of the main body casing 2; a paper feed roller 8 provided on the upper front side (in the following description, the right side in FIG. 1 indicates the front side and the left side indicates the back side) of the paper cassette 7; a paper feed path 9 provided on the upper front side of the paper feed roller 8; a pair of transport rollers 10 provided in the middle of the paper feed path 9; and a pair of resist rollers 11 provided at a downstream-side end portion of the paper feed path 9.

Sheets of paper 3 are stacked in the paper cassette 7, and a top sheet of paper 3 is sent out to the paper feed path 9 by the rotation of the paper feed roller 8. The paper feed path 9 is formed as a substantially U-shaped transport path for sheets of paper 3 such that the upstream-side end portion is, on the lower side, adjacent to the paper feed roller 8 and the sheet of paper 3 is fed toward the front, and that the downstream-side end portion is, on the upper side, adjacent to a transport belt 81 (described later) and the sheet of paper 3 is ejected toward the back. The sheet of paper 3 sent out to the paper feed path 9 is transported by the transport rollers 10 within the paper feed path 9 and the transport direction is reversed back and forth. Thereafter, the sheet of paper 3 is applied with a resist by the resist rollers 11 and then fed toward the back by the resist rollers 11.

### Configuration of the Image Forming Portion 5

The image forming portion 5 includes a scanner unit 12 serving as an optical scanning device, the process portions 13, and a transfer portion 14, and a fusing portion 15. The scanner unit 12 is disposed, within the main body casing 2, at the top and over the process portions 13. The configuration of the scanner unit 12 will be described later.

### Configuration of the Process Portions 13

As shown in FIG. 1, a plurality of process portions 13 are provided so as to correspond to a plurality of color toners, respectively. Specifically, four process portions 13 are provided including a yellow process portion 13Y, a magenta process portion 13M, a cyan process portion 13C, and a black process portion 13K. The process portions 13 are sequentially disposed in parallel with one another, so as to be spaced apart from one another from the front to the back and to be aligned in the horizontal direction. Each process portion 13 includes a photosensitive drum 71 serving as a photosensitive body, a scorotron charger 72, and a development cartridge 73.

Each photosensitive drum 71 is formed in a cylindrical shape. The photosensitive drum 71 has a drum main body formed of a positively chargeable photosensitive layer whose outermost layer is made from polycarbonate or the like; and a drum shaft that extends, in the axial center of the drum main body, along the axial direction of the drum main body. The drum main body is provided so as to be rotatable about the drum shaft. The drum shaft is supported at both side walls, in the width direction, of the process portion 13 so as not to be rotatable. Upon image formation, the photosensitive drum 71 is driven for rotation in the same direction (i.e., clockwise in the drawing) as a moving direction, at a contact position with the transport belt 81, of the transport belt 81 (described later).

Each scorotron charger 72 has a wire and a grid. The scorotron charger 72 is a positively chargeable scorotron charger that generates a corona discharge by the application of a charging bias. The scorotron charger 72 is disposed at the back of the photosensitive drum 71 and opposite the photosensitive drum 71 with a space provided therebetween so as not to contact with the photosensitive drum 71. The development cartridge 73 includes, in a housing thereof, a development roller 76 serving as a developer supplying unit, a supply roller 77, and a layer-thickness regulating blade 78.

The development roller 76 is disposed at the front of the photosensitive drum 71 and opposite the photosensitive drum 71. The development roller 76 has a metallic roller shaft that is covered with a roller portion made of an elastic member such as a conductive rubber material. More specifically, the roller portion is formed by a two-layer structure including a roller layer of an elastic body made of, for example, a conductive urethane rubber, silicone rubber, or EPDM rubber that contain carbon fine particles or the like; and a coat layer covering a surface of the roller layer and having, as its principal component, a urethane rubber, a urethane resin, a polyimide resin, or the like. The roller shaft of the development roller 76 is supported at both side walls, in the width direction, of the housing of the development cartridge 73 so as to be rotatable. Upon image formation, a development bias is applied to the roller shaft of the development roller 76.

The supply roller 77 is disposed at the front of the development roller 76 and opposite the development roller 76, and is pressure-welded to the development roller 76. The supply roller 77 has a metallic roller shaft that is covered with a roller portion made of a conductive sponge member. The roller shaft of the supply roller 77 is supported at both side walls, in the width direction, of the housing of the development cartridge 73 so as to be rotatable. The layer-thickness regulating blade 78 is made of a metallic plate spring member. The layer-thickness regulating blade 78 has, at its end, a pressing member having a semicircular shape when viewed from the cross section, which is made of an insulating silicone rubber. The layer-thickness regulating blade 78 is supported, on the upper side of the development roller 76, by the housing of the development cartridge 73. The pressing member at the end (the lower end) of the layer-thickness regulating blade 78 is pressure-welded to the development roller 76 from the upper front side.

An upper side portion of the housing of the development cartridge 73 is formed as a toner containing chamber 75 where toner is contained, and contains various color toners. Specifically, a toner containing chamber 75 of the yellow process portion 13Y contains therein a positively chargeable non-magnetic single-component polymerized toner having a yellow color. A toner containing chamber 75 of the magenta process portion 13M contains therein a positively chargeable non-magnetic single-component polymerized toner having a magenta color. A toner containing chamber 75 of the cyan process portion 13C contains therein a positively chargeable non-magnetic single-component polymerized toner having a cyan color. A toner containing chamber 75 of the black process portion 13K contains therein a positively chargeable non-magnetic single-component polymerized toner having a black color.

More specifically, for each color toner, a substantially spherical polymerized toner that is obtained by a polymerization method is used. A polymerized toner is obtained as follows. A binder resin obtained by copolymerizing a styrene monomer, such as styrene, or an acrylic monomer, such as acrylic acid, alkyl (C1 to C4) acrylate, or alkyl (C1 to C4) methacrylate, by a known polymerization method such as suspension polymerization, is used as a principal component. Into the binder resin are mixed a colorant, a charge control agent, a wax, and the like, whereby a toner base particle is formed. Further, to the toner base particle is added an external additive so as to improve fluidity, whereby a polymerized toner is obtained.

As the colorant, the aforementioned yellow, magenta, cyan, and black colorants are mixed. As the charge control agent, for example, a charge control resin is mixed that is obtained by copolymerizing an ionic monomer having an ionic functional group, such as ammonium salt, and an ionic monomer, such as a styrene monomer or an acrylic monomer, with a monomer that can be copolymerized with such ionic monomers. As the external additive, for example, metal oxide powder, such as silica, aluminum oxide, titanium oxide, strontium titanate, cerium oxide, or magnesium oxide, or inorganic powder, such as carbon powder or metal salt powder, is mixed.

In each process portion 13, upon image formation, a corresponding color toner contained in the toner containing chamber 75 is supplied to the supply roller 77 and then supplied, by the rotation of the supply roller 77, to the development roller 76. At this point, the toner is positively friction charged between the supply roller 77 and the development roller 76 to which a development bias is applied. The toner supplied onto the development roller 76 enters between the layer-thickness regulating blade 78 and the development roller 76 by the rotation of the development roller 76, whereby the toner becomes a thin layer of a constant thickness and is then supported on the development roller 76.

Each scorotron charger 72 generates a corona discharge by the application of a charging bias, thereby uniformly and positively charging the surface of its corresponding photosensitive drum 71. After the surface of the photosensitive drum 71 is uniformly and positively charged by the scorotron charger 72 by the rotation of the photosensitive drum 71, the surface of the photosensitive drum 71 is exposed by high-speed scanning with a laser beam (a first laser beam or a second laser beam) outputted from a corresponding light output window 21 of the scanner unit 12, whereby on the surface of the photosensitive drum 71 is formed an electrostatic latent image of a corresponding color according to an image to be formed on the sheet of paper 3.

By further rotation of the photosensitive drum 71, subsequently, the toner that is supported and positively charged on the surface of the development roller 76 is supplied, when opposing and coming into contact with the development roller 76 by the rotation of the development roller 76, to the electrostatic latent image formed on the surface of the photosensitive drum 71, i.e., an exposed portion of the uniformly and positively charged surface of the photosensitive drum 71 that has a potential reduced by laser beam exposure. By this, the electrostatic latent image of the photosensitive drum 71 is turned into a visible image, and a toner image of a corresponding color formed by reversal development is supported on the surface of the photosensitive drum 71.

### Configuration of the Transfer Portion 14

The transfer portion 14 is disposed, within the main body casing 2, above the paper cassette 7 and below the process portions 13 and along a front-back direction. The transfer portion 14 includes a drive roller 79, a driven roller 80, the transport belt 81, transfer rollers 82, and a belt cleaning portion 83.

The drive roller 79 is disposed further backward than and on the lower side of the photosensitive drum 71 of the black process portion 13K. Upon image formation, the drive roller 79 is driven for rotation in an opposite direction (i.e., counterclockwise in the drawing) to the rotating direction of the photosensitive drums 71. The driven roller 80 is disposed further forward than and on the lower side of the photosensitive drum 71 of the yellow process portion 13Y so as to be opposite, in the front-back direction, the drive roller 79. When the drive roller 79 is driven for rotation, the driven roller 80 rotates following the same direction (i.e., counterclockwise in the drawing) as the rotating direction of the drive roller 79.

The transport belt 81 is made of an endless belt and is formed of a resin such as a conductive polycarbonate or polyimide in which conductive particles, such as carbon, are dispersed. The transport belt 81 is wound around between the drive roller 79 and the driven roller 80. The transport belt 81 is disposed such that an outer contact surface of the wound transport belt 81 is opposed to and comes into contact with all the photosensitive drums 71 of the process portions 13. By the drive of the drive roller 79, the driven roller 80 is driven following the drive roller 79, and the transport belt 81 is circularly moved between the drive roller 79 and the driven roller 80 in a direction indicated by the arrow A (i.e., counterclockwise in the drawing) such that the transport belt 81 rotates, at the contact surface opposite the photosensitive drums 71 of the process portions 13, in the same direction as that of the photosensitive drums 71.

The transfer rollers 82 are disposed, within the transport belt 81 wound around between the drive roller 79 and the driven roller 80, so as to be opposite the photosensitive drums 71 of the process portions 13, respectively, with the transport belt 81 interposed therebetween. Each transfer roller 82 has a metallic roller shaft that is covered with a roller portion made of an elastic member such as a conductive rubber material. The roller shaft of the transfer roller 82 extends along the width direction and is rotatably supported. Upon transfer, a transfer bias is applied to the roller shaft of the transfer roller 82. Each transfer roller 82 rotates, at the contact surface opposite the transport belt 81, in the same direction (i.e., counterclockwise in the drawing) as the circularly moving direction of the transport belt 81.

The sheet of paper 3 fed from the paper feeding portion 4 is transported such that the sheet of paper 3 sequentially passes, from the front to the back, image-forming locations between the transport belt 81 and the photosensitive drums 71 of the process portions 13 by the transport belt 81 that is circularly moved by the drive of the drive roller 79 and the following drive of the driven roller 80. Then, during the transport, a toner image of a corresponding color supported on the photosensitive drum 71 of each process portion 13 is sequentially transferred, whereby a color image is formed on the sheet of paper 3.

Specifically, for example, when a yellow toner image supported on the surface of the photosensitive drum 71 of the yellow process portion 13Y is transferred onto a sheet of paper 3, a magenta toner image supported on the surface of the photosensitive drum 71 of the magenta process portion 13M is then transferred over the sheet of paper 3 onto which the yellow toner image is already transferred. By performing the same operation, a cyan toner image supported on the surface of the photosensitive drum 71 of the cyan process portion 13C and a black toner image supported on the surface of the photosensitive drum 71 of the black process portion 13K are transferred over the sheet of paper 3, whereby a color image is formed on the sheet of paper 3.

In such color image formation, since the color laser printer 1 has an apparatus configuration of a tandem type in which a plurality of process portions 13 are provided so as to correspond to various colors, toner images of the various colors can be formed and a color image can be rapidly formed at substantially the same speed as that for forming a monochrome image. Accordingly, a color image can be formed while miniaturizing the printer.

The belt cleaning portion 83 is disposed beneath the transport belt 81 and opposite the black process portion 13K with the transport belt 81 interposed therebetween. The belt cleaning portion 83 includes a primary cleaning roller 84 disposed so as to contact with the surface of the transport belt 81, for scraping off paper dust, toner, or the like adhered to the surface of the transport belt 81; a secondary cleaning roller 85 disposed so as to contact with the primary cleaning roller 84, for electrically collecting the paper dust, toner, or the like scraped off by the primary cleaning roller 84; a scraping blade 86 being in contact with the secondary cleaning roller 85, for scraping off the paper dust, toner, or the like collected by the secondary cleaning roller 85; and a cleaning box 87 for storing the paper dust, toner, or the like scraped off by the scraping blade 86.

In the belt cleaning portion 83, paper dust, toner, or the like adhered to the surface of the transport belt 81 is first scraped off by the primary cleaning roller 84, and then, the paper dust, toner, or the like scraped off by the primary cleaning roller 84 is electrically collected by the secondary cleaning roller 85. Subsequently, the paper dust, toner, or the like collected by the secondary cleaning roller 85 is scraped off by the scraping blade 86 and then is stored in the cleaning box 87.

### Configuration of the Fusing Portion 15

The fusing portion 15 is disposed at the back of the transfer portion 14. The fusing portion 15 includes a heat roller 88, a press roller 89, and transport rollers 90. The heat roller 88 is made of a metal base tube having a releasing layer formed on a surface of the metal base tube. A halogen lamp is installed in the heat roller 88 along an axial direction of the heat roller 88. By the halogen lamp, the surface of the heat roller 88 is heated to a fusing temperature. The press roller 89 is provided so as to press the heat roller 88. The transport rollers 90 consist of a pair of top and bottom rollers, and are disposed at the back of the heat roller 88 and the press roller 89.

The color image transferred onto the sheet of paper 3 is then transported to the fusing portion 15, and heated and pressured while passing between the heat roller 88 and the press roller 89, whereby the color image is heat-fused to the sheet of paper 3. The heat-fused sheet of paper 3 is sent to the paper ejecting portion 6 by the transport rollers 90.

### Configuration of the Paper Ejecting Portion 6

The paper ejecting portion 6 includes a paper ejecting path 91, paper ejecting rollers 92, and a paper ejection tray 93. The paper ejecting path 91 is formed as a substantially U-shaped transport path for sheets of paper 3 such that the upstream-side end portion is, on the lower side, adjacent to the transport rollers 90 and the sheet of paper 3 is transported toward the back, and that the downstream-side end portion is, on the upper side, adjacent to the paper ejecting rollers 92 and the sheet of paper 3 is ejected toward the front. The paper ejecting rollers 92 are provided, as a pair of rollers, on the downstream-side end portion of the paper ejecting path 91. The paper ejection tray 93 is formed on an upper surface of the main body casing 2 as a sloping wall that is sloped downward from the front to the back. After the sheet of paper 3 sent from the transport rollers 90 is reversed back and forth in its transport direction within the paper ejecting path 91, the sheet of paper 3 is ejected toward the front by the paper ejecting rollers 92. The ejected sheet of paper 3 is placed on the paper ejection tray 93.

The configurations of the scanner units 12 according to two embodiments (a first embodiment and a second embodiment) will be described in detail below.

### Configuration of the Scanner Unit 12 According to the First Embodiment

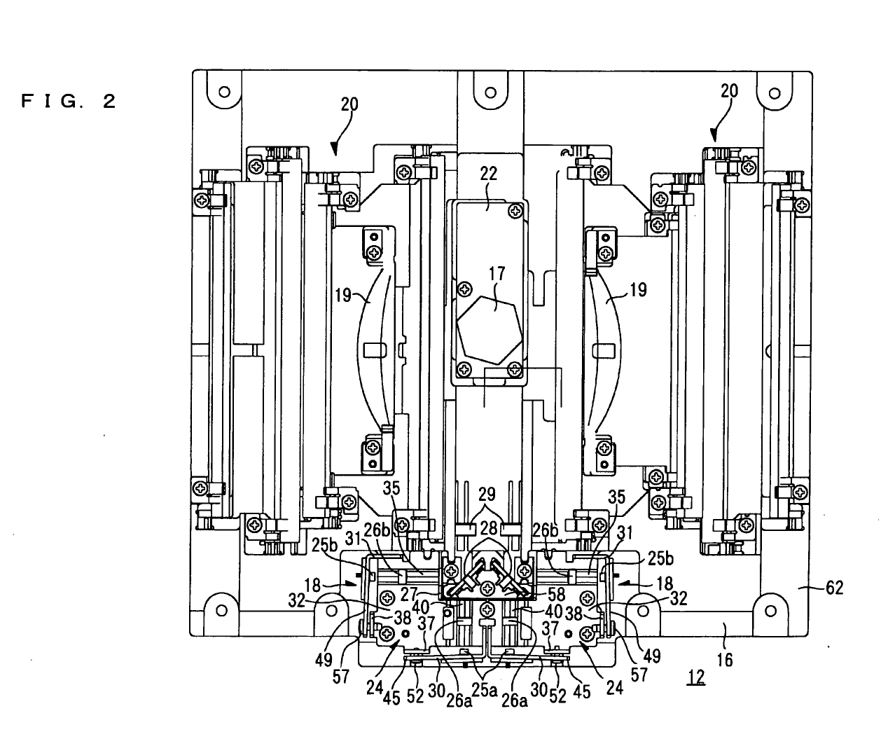

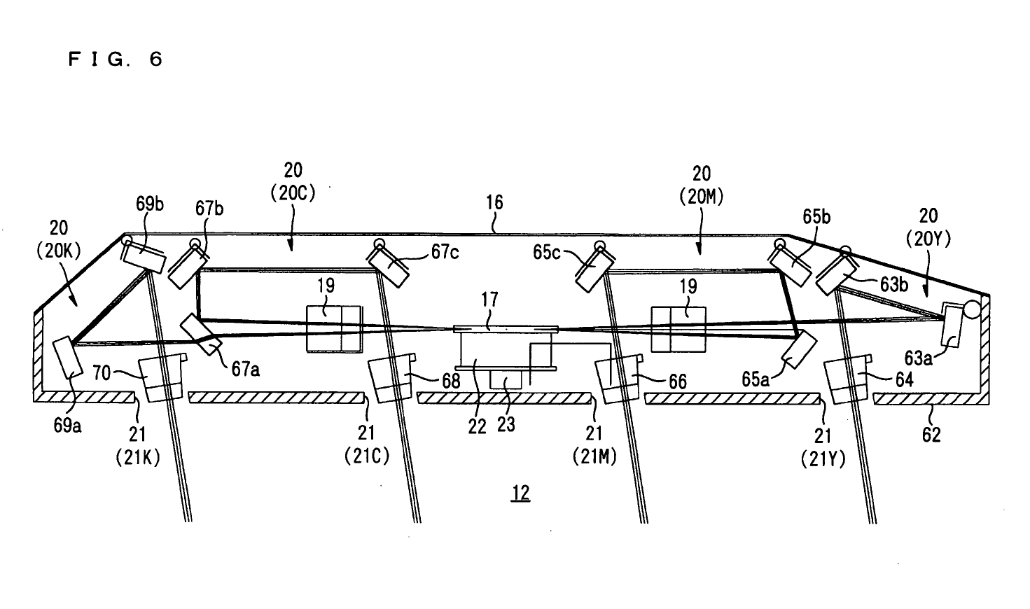

As shown in FIGS. 2 and 6, the scanner unit 12 according to the first embodiment includes a scanner casing 16; a polygon mirror 17 provided in the scanner casing 16 and serving as a light deflecting unit; laser irradiation optical portions 18 for irradiating laser beams onto the polygon mirror 17; fθ lenses 19 that convert the laser beams deflected and scanned by the polygon mirror 17 into parallel pencils of rays of uniform velocity; and laser output optical portions 20 for allowing the laser beams having passed through the fθ lenses 19 to be outputted as laser beams corresponding to various colors.

As shown in FIG. 6, the scanner casing 16 is in a box shape, and has light output windows 21 formed at a bottom wall 62 of the scanner casing 16 so as to correspond to various colors, respectively. The light output windows 21 are provided at different locations in a front-back direction and with a space provided therebetween. The light output windows 21 are formed so as to correspond to various colors, respectively, i.e., formed sequentially, from the front to the back, as a yellow light output window 21Y, a magenta light output window 21M, a cyan light output window 21C, and a black light output window 21K.

A single polygon mirror 17 is provided with respect to two first laser emitting portions 25a and two second laser emitting portions 25b (described later), in the center, in the front-back direction, of the scanner casing 16 and on a motor board 22. The polygon mirror 17 is in the form of a polyhedron (e.g., a hexahedron) having a plurality of deflecting surfaces. The polygon mirror 17 is driven for rotation at high speed by the power of a scanner motor placed in the motor board 22, with a rotating shaft 23, which is provided in the center of the polygon mirror 17, as the center of rotation. Note that the motor board 22 is fixed onto the bottom wall 62 of the scanner casing 16 through a boss or the like (not shown).

As shown in FIG. 2, two laser irradiation optical portions 18 are provided with respect to the polygon mirror 17, on one side in a width direction (which is a direction orthogonal to the front-back direction and an up-down direction of the color laser printer 1 and which indicates, in the following explanation, the width direction of the laser printer 1). Each laser irradiation optical portion 18 includes, as a set, a position adjustment frame 24 serving as an optical element; the first laser emitting portion 25a and the second laser emitting portion 25b that are held by the position adjustment frame 24; a first collimating lens 26a serving as a first lens and a second collimating lens 26b serving as a second lens that are supported by the position adjustment frame 24; a slit plate 27 serving as a slit member; a reflecting mirror 28 serving as a light reflecting unit; and a cylindrical lens 29.

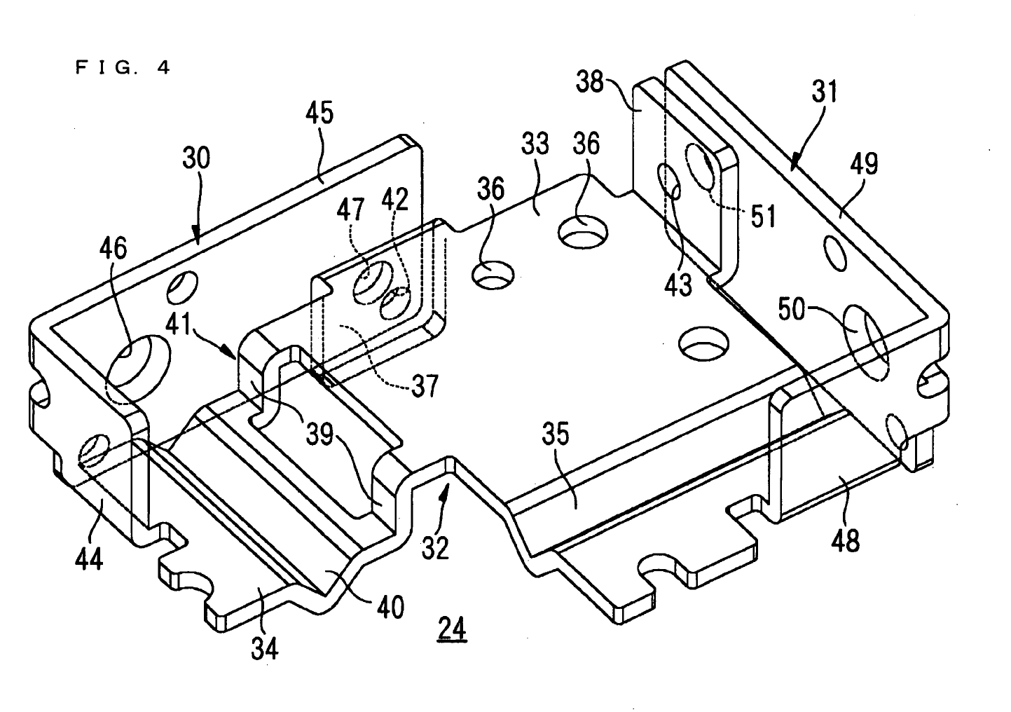

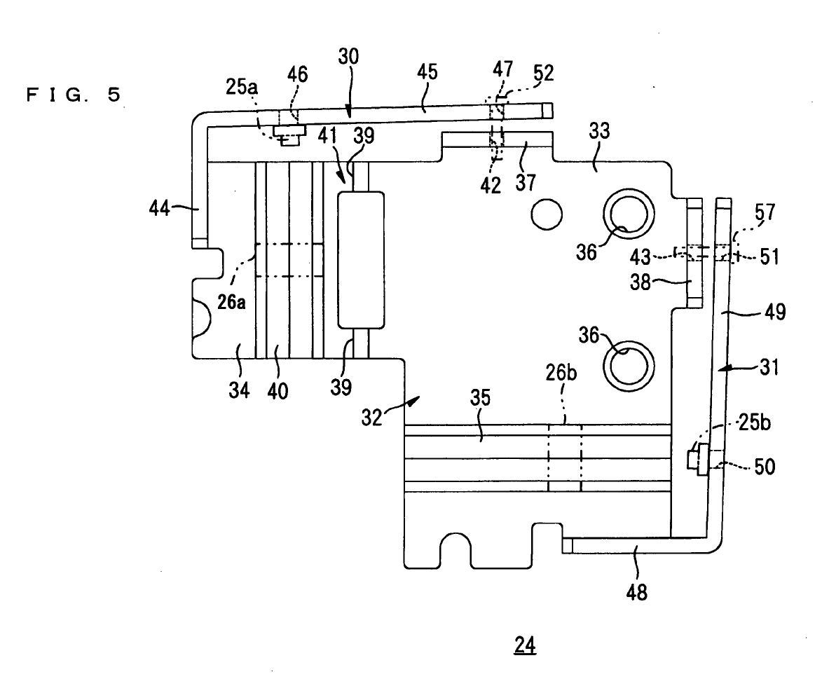

As shown in FIGS. 4 and 5, the position adjustment frame 24 is formed by bending a single sheet metal. More specifically, the position adjustment frame 24 continuously and integrally includes a first holder plate 30 serving as a first holding member that holds the first laser emitting portion 25a; a second holder plate 31 serving as a second holding member that holds the second laser emitting portion 25b; and a base plate 32 serving as a base member that supports the first collimating lens 26a and the second collimating lens 26b.

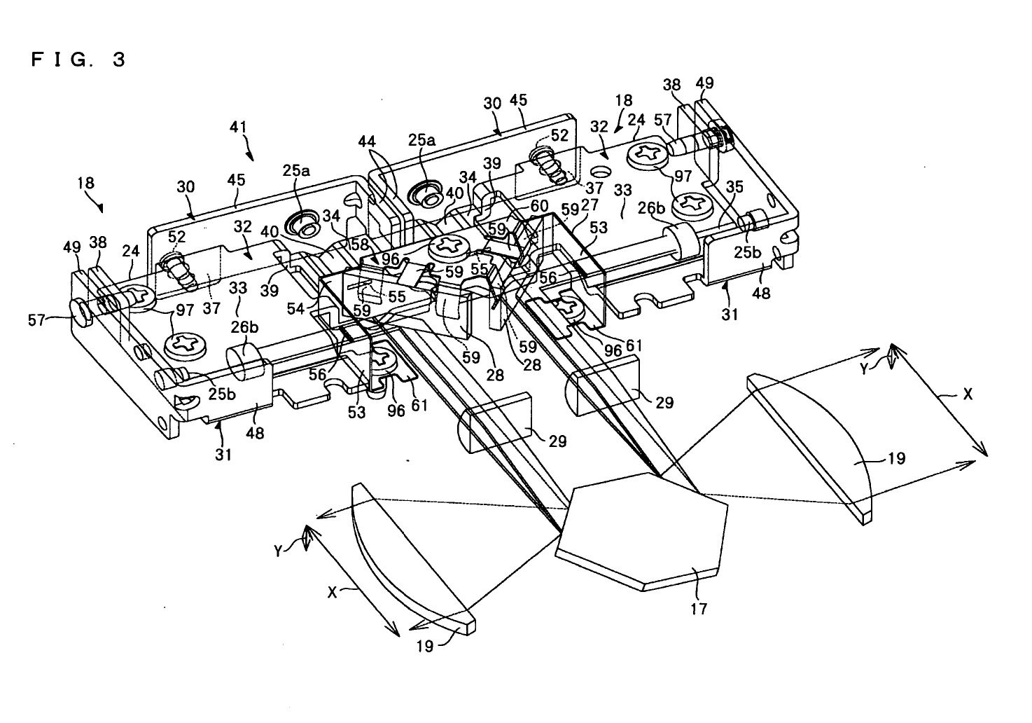

The base plate 32 integrally includes a fixing plate 33 serving as a supporting member that is fixed to a boss (not shown) of the scanner casing 16; a support plate 34 that supports the first collimating lens 26a; and connecting rods 39. The fixing plate 33 is made of a flat plate having a substantially rectangular shape when viewed from the top. The fixing plate 33 has formed therein/thereto a second lens groove 35 serving as a second-lens supporting portion used to support the second collimating lens 26b; fixing holes 36 used to fix the fixing plate 33 onto the bottom wall 62 of the scanner casing 16; a first-screw fixing plate 37 serving as a first-screw inserting and fixing portion used to fix a first screw 52 (see FIG. 3); and a second-screw fixing plate 38 serving as a second-screw inserting and fixing portion used to fix a second screw 57 (see FIG. 3).

The second lens groove 35 is formed such that an inner end portion, in the width direction, of the fixing plate 33 is bent in a substantially V-shape when viewed from the cross section, and along the front-back direction of the fixing plate 33. Two fixing holes 36 are formed at one end portion, in the front-back direction, of the fixing plate 33 and with a space provided therebetween in the width direction. Each fixing hole 36 is formed so as to penetrate through the fixing plate 33 in the thickness direction of the fixing plate 33.

The first-screw fixing plate 37 is made of a substantially rectangular flat plate extending in the up-down direction. The first-screw fixing plate 37 is formed by bending, at an outer end edge in the width direction of the fixing plate 33, the end edge of the fixing plate 33 downward in a substantially right angle direction. The first-screw fixing plate 37 has formed in the center thereof a first screwing hole 42 having a circular shape when viewed from the cross section, into which the first screw 52 (described later) is screwed, so as to penetrate through the first-screw fixing plate 37 in its thickness direction. The second-screw fixing plate 38 is made of a substantially rectangular flat plate extending in the up-down direction. The second-screw fixing plate 38 is formed by bending, at one end edge in the frond-back direction of the fixing plate 33, the end edge of the fixing plate 33 upward in a substantially right angle direction. The second-screw fixing plate 38 has formed in the center thereof a second screwing hole 43 having a circular shape when viewed from the cross section, into which the second screw 57 (described later) is screwed, so as to penetrate through the second-screw fixing plate 38 in its thickness direction. By this, the first-screw fixing plate 37 and the second-screw fixing plate 38 are disposed at substantially right angles to each other when viewed from the top, and are bent in directions opposite to each other with respect to the fixing plate 33.

The support plate 34 is disposed on the other side, in the front-back direction, of the fixing plate 33, and is provided so as to be continuous with the fixing plate 33 through the connecting rods 39. The support plate 34 is made of a flat plate having a substantially rectangular shape when viewed from the top, whose outer end edge in the width direction of the plate is flush, in the width direction, with the outer end edge in the width direction of the fixing plate 33. The support plate 34 has formed therein a first lens groove 40 serving as a first-lens supporting portion used to support the first collimating lens 26a. The first lens groove 40 is formed such that the center, in the front-back direction, of the support plate 34 is bent in a substantially V-shape when viewed from the cross section, and along the width direction of the support plate 34.

Two connecting rods 39 are provided with a space provided therebetween in the width direction, and along the up-down direction. Each connecting rod 39 is formed such that an upper end portion of the connecting rod 39 is bent downward in a substantially right angle direction from the other end portion, in the front-back direction, of the fixing plate 33, and that an lower end portion of the connecting rod 39 is bent upward in a substantially right angle direction from one end portion, in the front-back direction, of the support plate 34. By this, a step portion 41 is formed between the support plate 34 and the fixing plate 33 with the support plate 34 being disposed on the upper side and the fixing plate 33 being disposed on the lower side.

The first holder plate 30 is made of a flat plate having a substantially L shape when viewed from the top, which integrally includes a first short plate 44 and a first long plate 45 that serves as a first holding portion and a first-screw inserting portion. The first short plate 44 and the first long plate 45 are continuous at substantially right angles to each other. The first short plate 44 is formed such that the other end edge, in the front-back direction, of the support plate 34 is bent upward in a substantially right angle direction from the end edge of the support plate 34 so that a lower end edge of the first short plate 44 and the other end edge, in the front-back direction, of the support plate 34 are continuous with each other.

The first long plate 45 is formed such that an outer end edge, in the width direction, of the first short plate 44 is bent toward one side in the front-back direction and in a substantially right angle direction so that an free end portion, in the front-back direction, of the first long plate 45 is disposed opposite the first-screw fixing plate 37 with a space provided therebetween in the width direction. By this, the midpoint, in the front-back direction, of the first long plate 45 is disposed opposite the first lens groove 40 with a space provided therebetween in the width direction. The first long plate 45 has a first holding hole 46 having a circular shape when viewed from the cross section and allowing the first laser emitting portion 25a to be held thereinto. The first holding hole 46 is formed at a location opposite, in the width direction, the first lens groove 40 so as to penetrate through the first long plate 45 in its thickness direction. In addition, the first long plate 45 has a first insertion hole 47 having a circular shape when viewed from the cross section and allowing the first screw 52 (described later) to be inserted thereinto. The first insertion hole 47 is formed at a location opposite, in the width direction, the first screwing hole 42 so as to penetrate through the first long plate 45 in its thickness direction.

The second holder plate 31 is made of a flat plate having a substantially L shape when viewed from the top, which integrally includes a second short plate 48 and a second long plate 49 that serves as a second holding portion and a second-screw inserting portion. The second short plate 48 and the second long plate 49 are continuous at substantially right angles to each other. The second short plate 48 is formed such that an inner end edge, in the width direction, of the fixing plate 33 is bent upward in a substantially right angle direction from the end edge of the fixing plate 33 so that a lower end edge of the second short plate 48 and the inner end edge, in the width direction, of the fixing plate 33 are continuous with each other.

The second long plate 49 is formed such that one end edge, in the front-back direction, of the second short plate 48 is bent outward in the width direction and in a substantially right angle direction so that an free end portion, in its width direction, of the second long plate 49 is disposed opposite the second-screw fixing plate 38 with a space provided therebetween in the front-back direction. By this, the midpoint, in the width direction, of the second long plate 49 is disposed opposite the second lens groove 35 with a space provided therebetween in the front-back direction. The second long plate 49 has a second holding hole 50 having a circular shape when viewed from the cross section and allowing the second laser emitting portion 25b to be held thereinto. The second holding hole 50 is formed at a location opposite, in the front-back direction, the second lens groove 35 so as to penetrate through the second long plate 49 in its thickness direction. In addition, the second long plate 49 has a second insertion hole 51 having a circular shape when viewed from the cross section and allowing the second screw 57 (described later) to be inserted thereinto. The second insertion hole 51 is formed at a location opposite, in the front-back direction, the second screwing hole 43 so as to penetrate through the second long plate 49 in its thickness direction.

By this, the first long plate 45 of the first holder plate 30 and the second long plate 49 of the second holder plate 31 are disposed at substantially right angles to each other when viewed from the top.

As shown in FIG. 3, each first laser emitting portion 25a is made of a semiconductor laser or the like, and is placed in its corresponding first holding hole 46 so that a first laser beam can be outputted inward in the width direction. Each second laser emitting portion 25b is made of a semiconductor laser or the like, and is placed in its corresponding second holding hole 50 so that a second laser beam can be outputted toward the other side in the front-back direction.

As shown in FIG. 2, each first collimating lens 26a is installed in its corresponding first lens groove 40 with a space provided, in the width direction, between the first collimating lens 26a and its corresponding first laser emitting portion 25a. By this, the first laser emitting portion 25a and the first collimating lens 26a are disposed opposite each other and with a space provided therebetween in the width direction. Each second collimating lens 26b is installed in its corresponding second lens groove 35 with a space provided, in the front-back direction, between the second collimating lens 26b and its corresponding second laser emitting portion 25b. By this, the second laser emitting portion 25b and the second collimating lens 26b are disposed opposite each other and with a space provided therebetween in the front-back direction.

The relative position between the first laser emitting portion 25a and the first collimating lens 26a is adjusted as follows. Specifically, as shown in FIG. 5, first, the first screw 52 is inserted into the first insertion hole 47 externally in the width direction, and is then screwed into the first screwing hole 42. Thereafter, the first screw 52 is screwed forward or backward against the first screwing hole 42. Note that the first screw 52 is formed such that the head of the first screw 52 is larger in diameter than the first insertion hole 47.

By screwing the first screw 52 forward against the first screwing hole 42, with a connecting portion between the first long plate 45 and the first short plate 44 (i.e., a bending portion of the first holder plate 30) as a fulcrum, a free end portion of the first long plate 45 on the other side of the connecting portion is bent inward in the width direction and comes close to the first-screw fixing plate 37. By this, the first laser emitting portion 25a placed into the first long plate 45 comes close to the first collimating lens 26a installed in the first lens groove 40, and as a result, the relative distance between the first laser emitting portion 25a and the first collimating lens 26a decreases.

On the other hand, by screwing the first screw 52 backward against the first screwing hole 42, with the connecting portion between the first long plate 45 and the first short plate 44 as a fulcrum, the free end portion of the first long plate 45 is bent outward in the width direction and moves away from the first-screw fixing plate 37. By this, the first laser emitting portion 25a placed into the first long plate 45 moves away from the first collimating lens 26a installed in the first lens groove 40, and as a result, the relative distance between the first laser emitting portion 25a and the first collimating lens 26a increases.

By adjusting the relative distance between the first laser emitting portion 25a and the first collimating lens 26a by thus screwing the first screw 52 forward or backward against the first screwing hole 42, the relative position between the first laser emitting portion 25a and the first collimating lens 26a is adjusted.

The relative position between the second laser emitting portion 25b and the second collimating lens 26b is adjusted as follows. Specifically, first, the second screw 57 is inserted into the second insertion hole 51 from one side in the front-back direction, and is then screwed into the second screwing hole 43. Thereafter, the second screw 57 is screwed forward or backward against the second screwing hole 43. Note that the second screw 57 is formed such that the head of the second screw 57 is larger in diameter than the second insertion hole 51.

By screwing the second screw 57 forward against the second screwing hole 43, with a connecting portion between the second long plate 49 and the second short plate 48 (i.e., a bending portion of the second holder plate 31) as a fulcrum, a free end portion of the second long plate 49 on the other side of the connecting portion is bent toward the other side in the front-back direction and comes close to the second-screw fixing plate 38. By this, the second laser emitting portion 25b placed into the second long plate 49 comes close to the second collimating lens 26b installed in the second lens groove 35, and as a result, the relative distance between the second laser emitting portion 25b and the second collimating lens 26b decreases.

On the other hand, by screwing the second screw 57 backward against the second screwing hole 43, with the connecting portion between the second long plate 49 and the second short plate 48 as a fulcrum, the free end portion of the second long plate 49 is bent toward the one side in the front-back direction and moves away from the second-screw fixing plate 38. By this, the second laser emitting portion 25b placed into the second long plate 49 moves away from the second collimating lens 26b installed in the second lens groove 35, and as a result, the relative distance between the second laser emitting portion 25b and the second collimating lens 26b increases.

By adjusting the relative distance between the second laser emitting portion 25b and the second collimating lens 26b by thus screwing the second screw 57 forward or backward against the second screwing hole 43, the relative position between the second laser emitting portion 25b and the second collimating lens 26b is adjusted.

As shown in FIG. 2, two position adjustment frames 24 each thus provided with the first laser emitting portion 25a, the second laser emitting portion 25b, the first collimating lens 26a, and the second collimating lens 26b, are disposed with respect to the polygon mirror 17, on one side in the width direction so as to be adjacent to each other. The position adjustment frames 24 are disposed such that a set of laser beams and another set of laser beams pass through the reflecting mirrors 28 and the cylindrical lenses 29 and then enter the polygon mirror 17 parallel to each other, as will be described later. The set of laser beams includes a first laser beam and a second laser beam emitted from the first laser emitting portion 25a and the second laser emitting portion 25b of one of the position adjustment frames 24, respectively. The another set of laser beams includes a first laser beam and a second laser beam emitted from the first laser emitting portion 25a and the second laser emitting portion 25b of the other position adjustment frame 24, respectively. More specifically, as shown in FIG. 3, the two position adjustment frames 24 are disposed adjacent to each other along the front-back direction such that the support plates 34 are butted against each other in the front-back direction and the first short plates 44 are disposed opposite each other in the front-back direction.

In each of the position adjustment frames 24 thus disposed, a location where the first laser emitting portion 25a held into the first holding hole 46 and the first collimating lens 26a installed in the first lens groove 40 are disposed is different, in the sub scanning direction Y (which corresponds to the up-down direction), from a location where the second laser emitting portion 25b held into the second holding hole 50 and the second collimating lens 26b installed in the second lens groove 35 are disposed. Specifically, in the up-down direction, the first laser emitting portion 25a and the first collimating lens 26a are disposed on the lower side, and the second laser emitting portion 25b and the second collimating lens 26b are disposed on the upper side. Note that the position adjustment frames 24 are fixed onto the bottom wall 62 of the scanner casing 16 by fixing bolts 97 which are inserted into the fixing holes 36.

The slit plate 27 is installed over the two laser irradiation optical portions 18 and on the bottom wall 62 of the scanner casing 16. Specifically, the slit plate 27 is formed of a flat plate having a substantially C shape when viewed from the top, which integrally includes two side plates 53 disposed opposite each other with a space provided therebetween in the front-back direction and a main plate 54 that connects outer end portions, in the width direction, of the side plates 53. The slit plate 27 has formed therein first slit apertures 55 bored in the main plate 54 in the front-back direction so as to be spaced apart from each other; and a second slit aperture 56 bored in each side plate 53. Each of the first slit apertures 55 and the second slit apertures 56 is formed in a long hole shape extending in the main scanning direction X. Each first slit aperture 55 and each second slit aperture 56 are disposed with a space provided therebetween in the sub scanning direction Y, the space corresponding to the space between each first laser emitting portion 25a and each second laser emitting portion 25b.

The slit plate 27 is disposed over the two position adjustment frames 24 such that the second slit aperture 56 bored in one of the side plates 53 is opposite, in the front-back direction, the second lens groove 35 of one of the position adjustment frames 24; that the second slit aperture 56 bored in the other side plate 53 is opposite, in the front-back direction, the second lens groove 35 of the other position adjustment frame 24; that one of the first slit apertures 55 bored in the main plate 54 is opposite, in the width direction, the first lens groove 40 of the one position adjustment frame 24; and that the other first slit aperture 55 bored in the main plate 54 is opposite, in the width direction, the first lens groove 40 of the other position adjustment frame 24. More specifically, the slit plate 27 is disposed on the inner side, in the width direction, of the support plates 34 of the two position adjustment frames 24 so as to be sandwiched between the fixing plates 33 in the front-back direction.

In the slit plate 27, mounting plates 61 extending inward in a direction facing the side plates 53 are integrally formed at the inner side, in the width direction, of the side plates 53 so as to be bent from lower end edges of the side plates 53 in a substantially right angle direction. Each mounting plate 61 is made of a substantially rectangular flat plate, and has a mounting hole (not shown) bored in the center thereof. The slit plate 27 is fixed onto the bottom wall 62 of the scanner casing 16 by inserting fixing screws 96 into the mounting holes of the mounting plates 61 and screwing the inserted fixing screws 96 onto the bottom wall 62.

In addition, the slit plate 27 has a mirror positioning member 58 integrally formed thereto, which serves as a positioning unit for positioning and holding the reflecting mirrors 28. The mirror positioning member 58 integrally includes a top plate 60 formed so as to extend inward in the width direction from an upper end edge of the main plate 54 of the slit plate 27 and to be bent in a substantially right angle direction from the upper end edge; and holding plates 59 formed so as to be bent downward in a substantially right angle direction from inner end edges, in the width direction, of the top plate 60.

The top plate 60 is made of a flat plate having an isosceles triangular shape when viewed from the top. The holding plates 59 are made of pressing plate springs and are formed so as to be continuous from the top plate 60. Specifically, the holding plates 59 include central holding plates 59 each extending from a central hypotenuse portion of the top plate 60 in a direction orthogonal to the hypotenuse portion; and end holding plates 59 each extending such that the end holding plate 59 is bent from an end hypotenuse portion of the top plate 60 downward in a substantially right angle direction. The top plate 60 has a mounting hole (not shown) bored therein. The mirror positioning member 58 is fixed onto the bottom wall 62 of the scanner casing 16 by inserting a fixing screw 96 into the mounting hole of the top plate 60 and screwing the inserted fixing screw 96 into a boss (not shown) that stands out from the bottom wall 62.

The reflecting mirrors 28 are provided to the two laser irradiation optical portions 18, respectively. Each reflecting mirror 28 is made of a half-mirror and is disposed on the inner side of the slit plate 27. More specifically, one of the reflecting mirrors 28 is disposed so as to be tilted substantially 45° with respect to one of the side plates 53 and the main plate 54. The other reflecting mirror 28 is disposed so as to be tilted substantially 45° with respect to the other side plate 53 and the main plate 54. By this, the two reflecting mirrors 28 are disposed in a substantially L shape when viewed from the top, where the reflecting mirrors 28 are orthogonal to each other. Each reflecting mirror 28 is positioned and held by the holding plates 59 of the mirror positioning member 58 which are integrally formed with the slit plate 27. More specifically, each reflecting mirror 28 is held by the central holding plate 59 and the end holding plates 59 provided at the hypotenuses of the top plate 60, and positioned.

The cylindrical lenses 29 are provided to the two laser irradiation optical portions 18, respectively. Each cylindrical lens 29 has a refracting power only in the sub scanning direction Y. Each cylindrical lens 29 is installed on the bottom wall 62 of the scanner casing 16 such that the cylindrical lens 29 is disposed on the inner side, in the width direction, of its corresponding reflecting mirror 28 and opposite the reflecting mirror 28 with a space provided therebetween in the width direction. The cylindrical lenses 29 are disposed so as to be aligned along the front-back direction.

As shown in FIG. 3, in each laser irradiation optical portion 18, a first laser beam and a second laser beam emitted from the first laser emitting portion 25a and the second laser emitting portion 25b, respectively, pass through the first collimating lens 26a and the second collimating lens 26b, respectively. At this point, the first laser beam and the second laser beam are converted, by the first collimating lens 26a and the second collimating lens 26b, into parallel pencils of rays in the main scanning direction X and the sub scanning direction Y, respectively.

Subsequently, the first laser beam and the second laser beam having passed through the first collimating lens 26a and the second collimating lens 26b pass through the first slit aperture 55 and the second slit aperture 56 of the slit plate 27, respectively. Here, the first laser beam and the second laser beam are limited, by the first slit aperture 55 and the second slit aperture 56, in their cross-sectional shapes which are orthogonal to the optical paths of the first laser beam and the second laser beam; therefore, stray light of the first laser beam and the second laser beam emitted from the first laser emitting portion 25a and the second laser emitting portion 25b, respectively, is prevented.

Then, the first laser beam and the second laser beam having passed through the first slit aperture 55 and the second slit aperture 56, respectively, enter the reflecting mirror 28 while maintaining a space in the sub scanning direction Y therebetween. The first laser beam enters the lower part of the reflecting mirror 28 and directly and linearly passes through the reflecting mirror 28. The second laser beam enters the upper part of the reflecting mirror 28 and is reflected at substantially 90° and refracted at substantially right angles. By this, the optical paths of the first laser beam and the second laser beam are combined such that their relative positions in the main scanning direction X are matched.

Thereafter, the first laser beam and the second laser beam combined by the reflecting mirror 28 such that their relative positions in the main scanning direction X are matched, pass through the cylindrical lens 29 while maintaining the space in the sub scanning direction Y therebetween. The first laser beam and the second laser beam having passed through the cylindrical lens 29 are then refracted so as to converge in the sub scanning direction Y, so that the beams enter the polygon mirror 17 at different angles.

One set of laser beams outputted from one of the laser irradiation optical portions 18 and another set of laser beams outputted from the other laser irradiation optical portion 18 enter the polygon mirror 17 parallel to each other while maintaining a space in the front-back direction therebetween, and enter different deflecting surfaces of the polygon mirror 17 rotating at high speed. By this, the two sets of laser beams, each set including the first laser beam and the second laser beam, enter different deflecting surfaces of the polygon mirror 17. Note that, in the set of laser beams, the first laser beam and the second laser beam enter the same single deflecting surface at different angles.

The polygon mirror 17 deflects the two sets of laser beams by the high-speed rotation of the polygon mirror 17 and scans the deflected laser beams in the main scanning direction X. Since the first laser beam and the second laser beam of each set enter a deflecting surface of the polygon mirror 17 at different angles, the laser beams are reflected from the deflecting surface at angles at which the laser beams gradually move away from each other in the sub scanning direction Y (the up-down direction) (see FIG. 6).

Two fθ lenses 19 are provided for the two sets of laser beams, respectively. The fθ lenses 19 are provided in a direction orthogonal to a direction in which the two sets of laser beams enter the polygon mirror 17, and opposite each other with the polygon mirror 17 interposed therebetween. Each fθ lens 19 converts the first laser beam and the second laser beam that enter the polygon mirror 17 from the laser irradiation optical portion 18 and then are scanned by the polygon mirror 17 in the main scanning direction X, into parallel pencils of rays of uniform velocity.

As shown in FIG. 6, the laser output optical portions 20 are provided so as to correspond to various colors, respectively. Specifically, the laser output optical portions 20 include four laser output optical portions so as to correspond to various colors, respectively, i.e., a yellow optical portion 20Y, a magenta optical portion 20M, a cyan optical portion 20C, and a black optical portion 20K.

The yellow optical portion 20Y is disposed at the most forward part in the front-back direction. The yellow optical portion 20Y includes two reflecting mirrors 63a and 63b that reflect a first laser beam having passed through the upper part of one of the fθ lenses 19; and a cylindrical lens 64 that allows the first laser beam having been reflected off the reflecting mirrors 63a and 63b to pass therethrough. The first laser beam having passed through the upper part of the one fθ lens 19 is first, in the yellow optical portion 20Y, reflected off the reflecting mirror 63a diagonally backward and upward, and then, reflected off the reflecting mirror 63b downward in a substantially vertical direction. Thereafter, the first laser beam passes through the cylindrical lens 64 in a substantially vertical direction and then is outputted from the yellow light output window 21Y.

The magenta optical portion 20M is disposed between the polygon mirror 17 and the yellow optical portion 20Y. The magenta optical portion 20M includes three reflecting mirrors 65a, 65b, and 65c that reflect a second laser beam having passed through the lower part of the one fθ lens 19; and a cylindrical lens 66 that allows the second laser beam having been reflected off the reflecting mirrors 65a, 65b, and 65c to pass therethrough. The second laser beam having passed through the lower part of the one fθ lens 19 is first, in the magenta optical portion 20M, reflected off the reflecting mirror 65a upward, and then, reflected off the reflecting mirror 65b backward, and thereafter, reflected off the reflecting mirror 65c downward in a substantially vertical direction. Subsequently, the second laser beam passes through the cylindrical lens 66 in a substantially vertical direction and then is outputted from the magenta light output window 21M.

The cyan optical portion 20C is disposed between the polygon mirror 17 and the black optical portion 20K. The cyan optical portion 20C includes three reflecting mirrors 67a, 67b, and 67c that reflect a first laser beam having passed through the upper part of the other fθ lens 19; and a cylindrical lens 68 that allows the first laser beam having been reflected off the reflecting mirrors 67a, 67b, and 67c to pass therethrough. The first laser beam having passed through the upper part of the other fθ lens 19 is first, in the cyan optical portion 20C, reflected off the reflecting mirror 67a upward, and then, reflected off the reflecting mirror 67b forward, and thereafter, reflected off the reflecting mirror 67c downward in a substantially vertical direction. Subsequently, the first laser beam passes through the cylindrical lens 68 in a substantially vertical direction and then is outputted from the cyan light output window 21C.

The black optical portion 20K is disposed at the most backward part in the front-back direction. The black optical portion 20K includes two reflecting mirrors 69a and 69b that reflect a second laser beam having passed through the lower part of the other fθ lens 19; and a cylindrical lens 70 that allows the second laser beam having been reflected off the reflecting mirrors 69a and 69b to pass therethrough. The second laser beam having passed through the lower part of the other fθ lens 19 passes through the reflecting mirror 67a of the cyan optical portion 20C, and then is, first, in the black optical portion 20K, reflected off the reflecting mirror 69a diagonally forward and upward, and then reflected off the reflecting mirror 69b downward in a substantially vertical direction. Thereafter, the second laser beam passes through the cylindrical lens 70 in a substantially vertical direction and then is outputted from the black light output window 21K.

The magenta optical portion 20M and the cyan optical portion 20C are disposed symmetrical with respect to the polygon mirror 17. The yellow optical portion 20Y and the black optical portion 20K are disposed on the outer side of the magenta optical portion 20M and the cyan optical portion 20C so as to be symmetrical with respect to the polygon mirror 17.

In such a color laser printer 1, in the scanner unit 12, in each position adjustment frame 24, the first collimating lens 26a and the second collimating lens 26b are supported to the base plate 32 by allowing the first laser emitting portion 25a to be supported to the first holder plate 30 and allowing the second laser emitting portion 25b to be supported to the second holder plate 31. By this, the first laser emitting portion 25a and the first collimating lens 26a, and the second laser emitting portion 25b and the second collimating lens 26b are efficiently disposed, making it possible to simplify the configuration and to reduce costs.

Moreover, by inserting the first screw 52 into the first insertion hole 47 of the first long plate 45 and then adjusting the position of the first screw 52 with respect to the first screwing hole 42 of the first-screw fixing plate 37 and fixing the first screw 52, the relative position between the first long plate 45 and the first-screw fixing plate 37 is adjusted, whereby the position of the first laser emitting portion 25a can be adjusted with respect to the first collimating lens 26a. In addition, by inserting the second screw 57 into the second insertion hole 51 of the second long plate 49 and then adjusting the position of the second screw 57 with respect to the second screwing hole 43 of the second-screw fixing plate 38 and fixing the second screw 57, the relative position between the second long plate 49 and the second-screw fixing plate 38 is adjusted, whereby the position of the second laser emitting portion 25b can be adjusted with respect to the second collimating lens 26b. Thus, position adjustment between the first laser emitting portion 25a and the first collimating lens 26a and between the second laser emitting portion 25b and the second collimating lens 26b can be easily made.

Each position adjustment frame 24 continuously and integrally includes the first holder plate 30, the second holder plate 31, and the base plate 32. The position adjustment frame 24 is formed by bending a single sheet metal. Accordingly, a reduction in the number of components, a simplification of the configuration, and a reduction in costs can be achieved.

In each position adjustment frame 24, by screwing the first screw 52 inserted into the first insertion hole 47 of the first long plate 45 forward or backward against the first screwing hole 42 of the first-screw fixing plate 37, the relative position, in a direction in which the first long plate 45 and the first-screw fixing plate 37 are opposite each other, between the first long plate 45 and the first lens groove 40 disposed with a space provided therebetween is adjusted. This allows for accurate position adjustment of the first laser emitting portion 25a with respect to the first collimating lens 26a. By screwing the second screw 57 inserted into the second insertion hole 51 of the second long plate 49 forward or backward against the second screwing hole 43 of the second-screw fixing plate 38, the relative position, in a direction in which the second long plate 49 and the second-screw fixing plate 38 are opposite each other, between the second long plate 49 and the second lens groove 35 disposed with a space provided therebetween is adjusted. This allows for accurate position adjustment of the second laser emitting portion 25b with respect to the second collimating lens 26b.

In each laser irradiation optical portion 18, since the relative positions, in the main scanning direction X, of a first laser beam and a second laser beam are matched by the reflecting mirror 28, the first laser emitting portion 25a and the first collimating lens 26a, and the second laser emitting portion 25b and the second collimating lens 26b can be disposed at different locations in the sub scanning direction Y. This ensures an efficient layout of those components, making it possible to miniaturize the apparatus.

In each laser irradiation optical portion 18, a first laser beam having passed through the first collimating lens 26a and a second laser beam having passed through the second collimating lens 26b pass through the first slit aperture 55 and the second slit aperture 56, respectively, and then, enter the reflecting mirror 28. The first laser beam having passed through the first slit aperture 55 and the second laser beam having passed through the second slit aperture 56 are limited in their cross-sectional shapes by the first slit aperture 55 and the second slit aperture 56, respectively. Accordingly, interference between the first laser beam and the second laser beam is prevented. As a result, the relative positions, in the main scanning direction X, of the first laser beam and the second laser beam can be accurately matched using the reflecting mirror 28.

In the laser irradiation optical portions 18, since the mirror positioning member 58 that positions and holds the reflecting mirrors 28 is integrally formed with the slit plate 27, a reduction in the number of components and a simplification of the configuration can be achieved.

In each position adjustment frame 24, since the step portion 41 is provided along the sub scanning direction Y and between the support plate 34 having formed therein the first lens groove 40 and the fixing plate 33 having formed therein the second lens groove 35, the first lens groove 40 and the second lens groove 35 can be easily disposed at different locations in the sub scanning direction Y.

In addition, in each position adjustment frame 24, since the first long plate 45 of the first holder plate 30 and the second long plate 49 of the second holder plate 31 are disposed at substantially right angles to each other, the first laser emitting portion 25a held by the first long plate 45 and the second laser emitting portion 25b held by the second long plate 49 are disposed at substantially right angles to each other, and the relative positions, in the main scanning direction X, of the first laser beam and the second laser beam can be accurately matched using the reflecting mirror 28. Furthermore, an efficient layout of the first laser emitting portion 25a and the second laser emitting portion 25b can be ensured, making it possible to miniaturize the apparatus.

In each position adjustment frame 24, since the first-screw fixing plate 37 and the second-screw fixing plate 38 are bent in the up-down direction and in directions opposite to each other with respect to the fixing plate 33, by easy bending the first-screw fixing plate 37 and the second-screw fixing plate 38 can be disposed at different locations in the sub scanning direction Y.

In the scanner unit 12, two laser irradiation optical portions 18 are provided with respect to the polygon mirror 17, on one side in the width direction so as to be adjacent to each other. A set of laser beams (the first laser beam and the second laser beam) from one of the laser irradiation optical portions 18 and another set of laser beams from the other laser irradiation optical portion 18 enter different deflecting surfaces of the polygon mirror 17 parallel to each other. That is, in the scanner unit 12, two laser irradiation optical portions 18 are disposed such that sets of laser beams emitted from the laser irradiation optical portions 18, respectively, are irradiated onto different deflecting surfaces of the polygon mirror 17. Accordingly, an efficient layout is ensured, making it possible to miniaturize the apparatus.

The scanner unit 12 includes two laser irradiation optical portions 18. The scanner unit 12 can scan, using the polygon mirror 17, two first laser beams and two second laser beams, i.e., four laser beams, that are emitted from two first laser emitting portions 25a and two second laser emitting portions 25b. Thus, electrostatic latent images of yellow, magenta, cyan, and black are formed and a color image can be formed.

The laser irradiation optical portions 18 are disposed such that a set of laser beams from one of the laser irradiation optical portions 18 and another set of laser beams from the other laser irradiation optical portion 18 enter the polygon mirror 17 parallel to each other. Hence, the laser irradiation optical portions 18 can be disposed with respect to the polygon mirror 17 with a small space.

In the color laser printer 1, by four laser beams outputted from the scanner unit 12, electrostatic latent images are formed on the photosensitive drums 71, respectively. Thus, accurate electrostatic latent images are formed on the photosensitive drums 71 and an accurate color image can be formed.

### Configuration of the Scanner Unit 12 According to a Second Embodiment

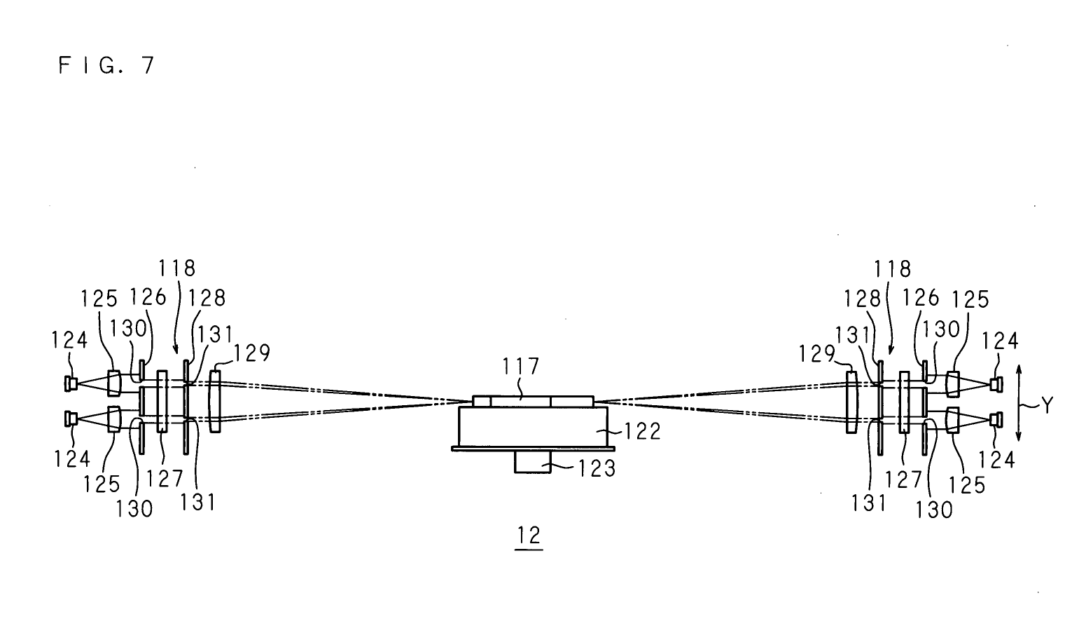

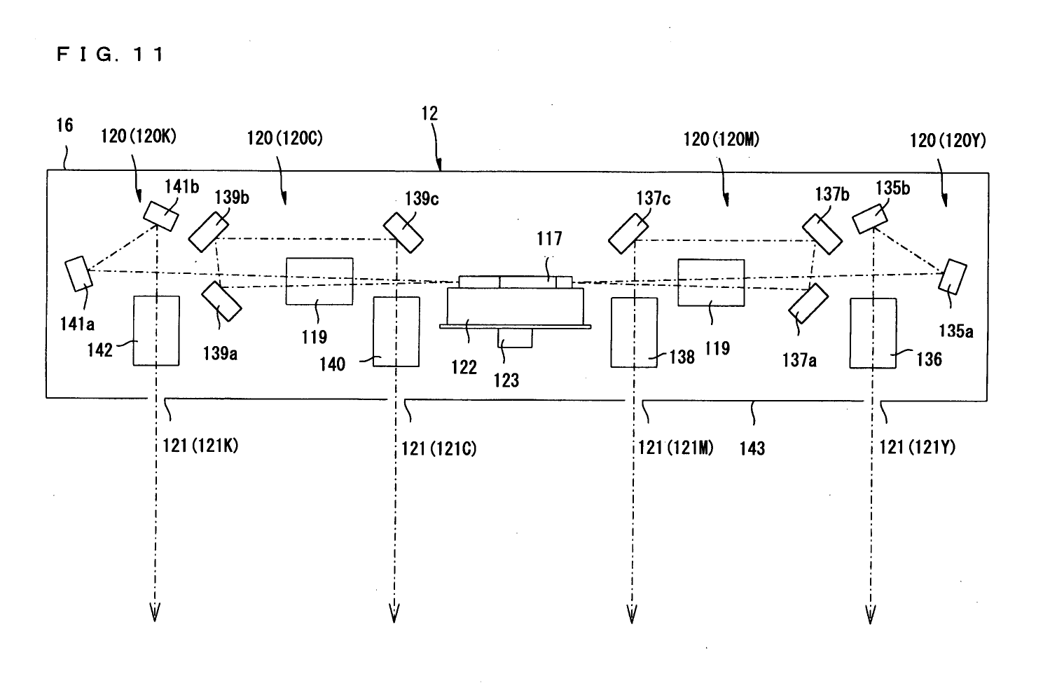

FIG. 7 is a side view of a configuration of a substantial part of a scanner unit 12 according to a second embodiment, viewed from the side. FIG. 11 is a side cross-sectional view of the scanner unit 12, viewed from the side. As shown in FIGS. 7 and 11, the scanner unit 12 includes a scanner casing 16; a polygon mirror 117 provided in the scanner casing 16 and serving as a light deflecting unit; laser irradiation optical portions 118 for irradiating laser beams onto the polygon mirror 117; fθ lenses 119 that convert the laser beams deflected and scanned by the polygon mirror 117 into pencils of rays of uniform velocity on an image surface; and laser output optical portions 120 serving as an optical path forming unit for allowing the laser beams having passed through the fθ lenses 119 to be outputted as laser beams corresponding to various colors.

As shown in FIG. 11, the scanner casing 16 is in a box shape, and has light output windows 121 formed at a bottom wall 143 of the scanner casing 16 so as to correspond to various colors, respectively. The light output windows 121 are provided at different locations in a front-back direction and with a space provided therebetween. The light output windows 121 are formed so as to correspond to various colors, respectively, i.e., formed sequentially, from the front to the back, as a yellow light output window 121Y, a magenta light output window 121M, a cyan light output window 121C, and a black light output window 121K.

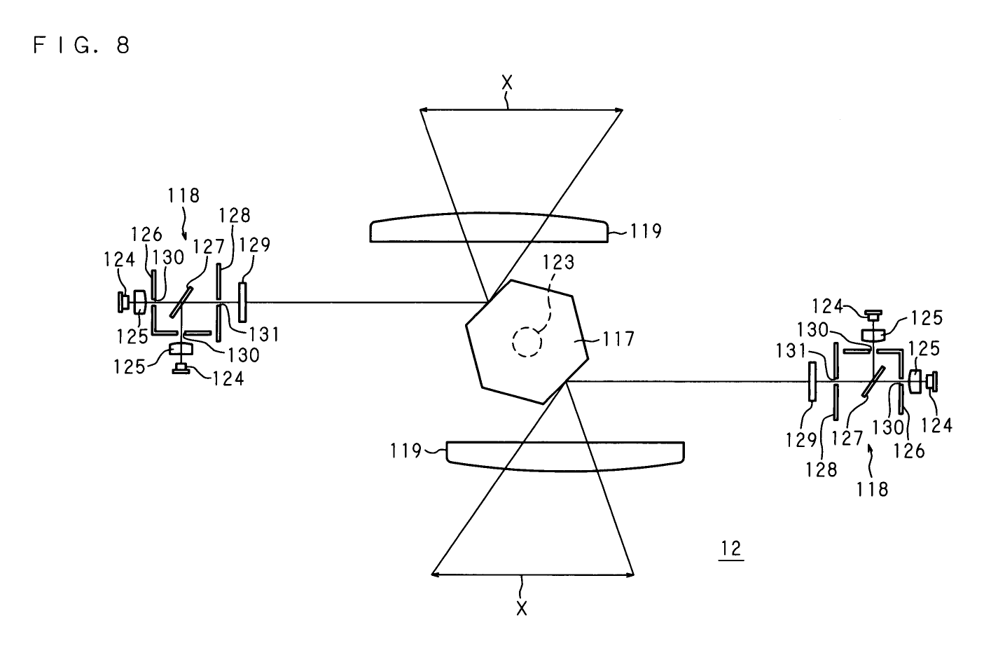

A single polygon mirror 117 is provided with respect to four laser emitting portions 124 (described later) in the center, in the front-back direction, of the scanner casing 16 and on a motor board 122. FIG. 8 is a plan view of the configuration of the substantial part of the scanner unit 12, viewed from above. As shown in FIG. 8, the polygon mirror 117 is in the form of a polyhedron (e.g., a hexahedron) having a plurality of reflecting surfaces. The polygon mirror 117 is driven for rotation at high speed by the power of a scanner motor placed in the motor board 122, with a rotating shaft 123, which is provided in the center of the polygon mirror 117, as the center of rotation. Note that the motor board 122 is fixed onto the bottom wall 143 of the scanner casing 16 through a boss or the like (not shown).

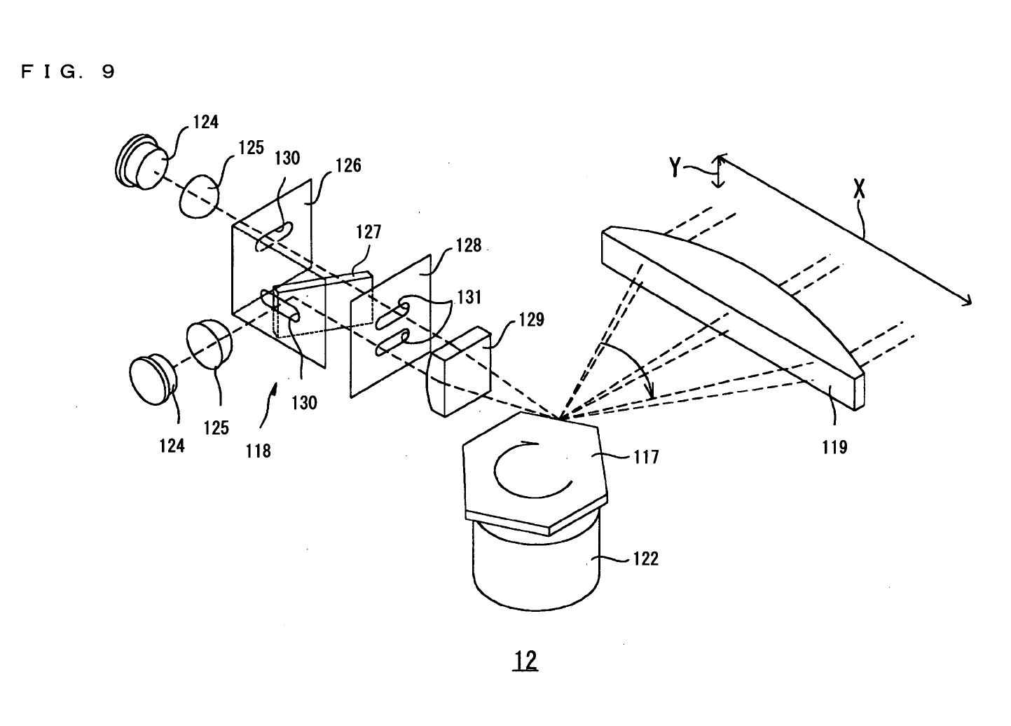

The laser irradiation optical portions 118 are provided symmetrical with respect to the polygon mirror 117. Each laser irradiation optical portion 118 includes, as a set, the laser emitting portions 124; collimating lenses 125; a first slit plate 126 serving as a stray-light preventing unit; a reflecting mirror 127 serving as an optical path combining unit; a second slit plate 128 serving as a slit member; and a cylindrical lens 129. Each laser emitting portion 124 is made of a semiconductor laser or the like. Two laser emitting portions 124 are provided, as a set, in each laser irradiation optical portion 118. The laser emitting portions 124 are disposed such that the optical paths of laser beams emitted from the laser emitting portions 124 are orthogonal to each other. As shown in FIG. 7, the laser emitting portions 124 are disposed with a space provided therebetween in a sub scanning direction Y (see FIG. 9).

FIG. 9 is a perspective view of the laser irradiation optical portion 118 of the scanner unit 12, viewed obliquely from the front side. As shown in FIG. 9, two collimating lenses 125 are provided for the laser emitting portions 124, respectively. Each collimating lens 125 is provided in a passing direction of a laser beam (hereinafter simply referred to as a “passing direction of a laser beam” ) emitted from its corresponding laser emitting portion 124 and on the downstream side of the laser emitting portion 124. The collimating lenses 125 are disposed opposite the laser emitting portions 124, respectively. A laser beam emitted from each laser emitting portion 124 is converted into a parallel pencil of rays by a corresponding collimating lens 125.

As shown in FIG. 8, the first slit plate 126 is made of a substantially L-shaped plate formed of two flat plates that continue at substantially right angles. As shown in FIG. 9, a first slit 130 is bored in each of the flat plates to prevent stray light. Each first slit 130 is formed in a long hole shape extending in a main scanning direction X. The first slits 130 are disposed with a space provided therebetween in the sub scanning direction Y, the space corresponding to the space between the laser emitting portions 124. The first slit plate 126 is disposed such that each first slit 130 is disposed in a passing direction of a laser beam and on the downstream side of its corresponding collimating lens 125, and opposite the collimating lens 125. A laser beam having passed through each collimating lens 125 is limited, by a corresponding first slit 130 of the first slit plate 126, in its cross-sectional shape which is orthogonal to the passing direction of the laser beam, whereby stray light of the laser beam emitted from each laser emitting portion 124 is prevented.

The reflecting mirror 127 is disposed in the passing direction of a laser beam and on the downstream side of each first slit 130. The reflecting mirror 127 is provided so as to be tilted substantially 45° with respect to each flat plate of the substantially L-shaped first slit plate 126. The reflecting mirror 127 is formed such that a laser beam having passed through one of the first slits 130 passes directly and linearly through the upper part of the reflecting mirror 127, and a laser beam having passed through the other first slit 130 is reflected off the lower part of the reflecting mirror 127 at substantially 90° and refracted at substantially right angles. By this, the optical paths of the two laser beams emitted from the two laser emitting portions 124 in directions orthogonal to each other are combined so as to be matched in the main scanning direction X.

The second slit plate 128 is disposed in the passing direction of a laser beam and on the downstream side of the reflecting mirror 127. The second slit plate 128 is made of a substantially rectangular flat plate. In the second slit plate 128, second slits 131, serving as diaphragm apertures, are bored so as to correspond to the laser emitting portions 124, respectively. Each second slit 131 is formed in a long hole shape extending in the main scanning direction X. The second slits 131 are disposed in parallel and with a space provided therebetween in the sub scanning direction Y (see FIG. 9), the space corresponding to the space between the laser emitting portions 124. The second slits 131 are formed such that the aperture area is smaller than that of the first slits 130 formed in the first slit plate 126, in order to narrow each laser beam. The laser beams having been combined in their optical paths in the main scanning direction X by the reflecting mirror 127 are adjusted in their positions in the sub scanning direction Y when passing through the second slits 131.

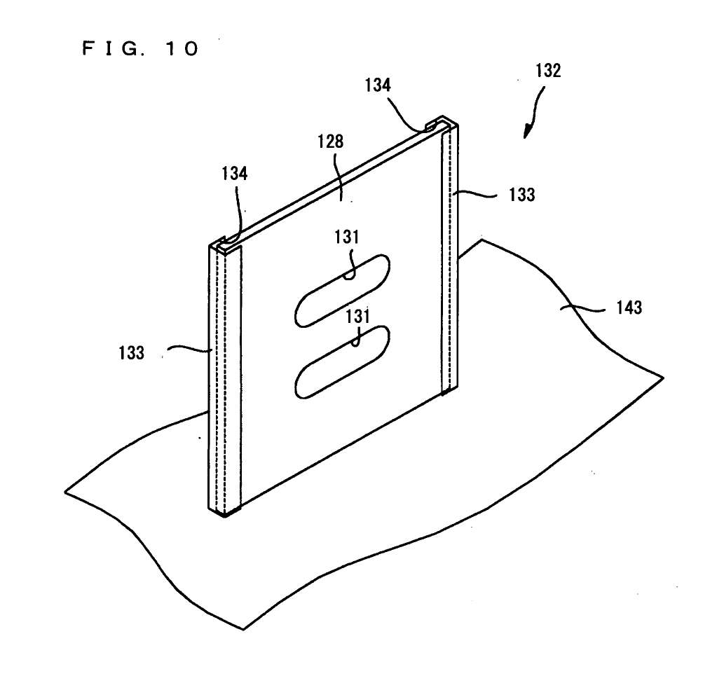

FIG. 10 is a perspective view of the second slits 131, viewed from the front side. As shown in FIG. 10, the second slit plate 128 is fixed by a guide member 132 that stands out from the bottom wall 143 of the scanner casing 16. Specifically, the guide member 132 includes two slide rods 133 disposed opposite each other with the second slit plate 128 interposed therebetween. Each slide rod 133 has formed therein a slide groove 134 with one side being open, which has a C shape when viewed from the cross section. The slide rods 133 are disposed spaced apart from each other so as to sandwich the second slit plate 128 therebetween. The slide rods 133 are provided standing out from the bottom wall 143 with the respective open sides of the slide grooves 134 being opposite each other.

End portions of the second slit plate 128 in its width direction (i.e., a direction orthogonal to the direction of the length and an up-down direction) are inserted from above into the slide grooves 134 of the slide rods 133 and then guided sliding downward along the slide grooves 134 until a lower end portion of the second slit plate 128 abuts the bottom wall 143, whereby the second slit plate 128 is placed in the guide member 132. The second slit plate 128 is positioned by the slide rods 133 and the bottom wall 143 with the second slit plate 128 being placed in the guide member 132.

The cylindrical lens 129 is disposed in the passing direction of a laser beam and on the downstream side of the second slit plate 128 and on the upstream side of the polygon mirror 117. The cylindrical lens 129 has a refracting power only in the sub scanning direction Y. As shown in FIG. 7, laser beams having passed through the second slits 131 of the second slit plate 128 are refracted by the cylindrical lens 129 so as to converge in the sub scanning direction Y, and then, enter the polygon mirror 117.

As shown in FIG. 8, the two laser irradiation optical portions 118 are disposed opposite to each other so as to be symmetrical with respect to the polygon mirror 117. Two laser beams refracted by the cylindrical lenses 129 of the laser irradiation optical portions 118 so as to converge in the sub scanning direction Y enter the polygon mirror 117 from opposite sides. By this, four laser beams enter the polygon mirror 117 from opposite sides, with two laser beams as a set. The polygon mirror 117 deflects two sets of laser beams (four laser beams in total) entering from opposite sides, by the high-speed rotation of the polygon mirror 17 and scans the deflected laser beams in the main scanning direction X. Since the two laser beams of each set enter a reflecting surface of the polygon mirror 117 at different angles, the laser beams are reflected from the reflecting surface at angles at which the laser beams gradually move away from each other in the sub scanning direction Y (the up-down direction).

Two fθ lenses 119 are provided for the two sets of laser beams, respectively. The two fθ lenses 119 are provided in a direction orthogonal to a direction in which the laser beams of each set enter the polygon mirror 117, and opposite each other with the polygon mirror 117 interposed therebetween. Each fθ lens 119 converts the two laser beams that enter the polygon mirror 117 from each laser irradiation optical portion 118 and then are scanned by the polygon mirror 117 in the main scanning direction X, into pencils of rays of uniform velocity on an image surface.

As shown in FIG. 11, the laser output optical portions 120 are provided so as to correspond to various colors, respectively. Specifically, the laser output optical portions 120 include four laser output optical portions so as to correspond to various colors, respectively, i.e., a yellow optical portion 120Y, a magenta optical portion 120M, a cyan optical portion 120C, and a black optical portion 120K.

The yellow optical portion 120Y is disposed at the most forward part in the front-back direction. The yellow optical portion 120Y includes two reflecting mirrors 135a and 135b that reflect a laser beam having passed through the upper part of one of the fθ lenses 119; and a toroidal lens 136 that allows the laser beam having been reflected off the reflecting mirrors 135a and 135b to converge in the sub scanning direction Y. The laser beam having passed through the upper part of the one fθ lens 119 is first, in the yellow optical portion 120Y, reflected off the reflecting mirror 135a diagonally backward and upward, and then, reflected off the reflecting mirror 135b downward in a vertical direction. Thereafter, the laser beam passes through the toroidal lens 136 in a vertical direction and then is outputted from the yellow light output window 121Y.

The magenta optical portion 120M is disposed between the polygon mirror 117 and the yellow optical portion 120Y. The magenta optical portion 120M includes three reflecting mirrors 137a, 137b, and 137c that reflect a laser beam having passed through the lower part of the one fθ lens 119; and a toroidal lens 138 that allows the laser beam having been reflected off the reflecting mirrors 137a, 137b, and 137c to converge in the sub scanning direction Y. The laser beam having passed through the lower side of the one fθ lens 119 is first, in the magenta optical portion 120M, reflected off the reflecting mirror 137a upward, and then, reflected off the reflecting mirror 137b backward, and thereafter, reflected off the reflecting mirror 137c downward in a vertical direction. Subsequently, the laser beam passes through the toroidal lens 138 in a vertical direction and then is outputted from the magenta light output window 121M.

The cyan optical portion 120C is disposed between the polygon mirror 117 and the black optical portion 120K. The cyan optical portion 120C includes three reflecting mirrors 139a, 139b, and 139c that reflect a laser beam having passed through the lower part of the other θ lens 119; and a toroidal lens 140 that allows the laser beam having been reflected off the reflecting mirrors 139a, 139b, and 139c to converge in the sub scanning direction Y. The laser beam having passed through the lower part of the other fθ lens 119 is first, in the cyan optical portion 120C, reflected off the reflecting mirror 139a upward, and then, reflected off the reflecting mirror 139b forward, and thereafter, reflected off the reflecting mirror 139c downward in a vertical direction. Subsequently, the laser beam passes through the toroidal lens 140 in a vertical direction and then is outputted from the cyan light output window 121C.

The black optical portion 120K is disposed at the most backward part in the front-back direction. The black optical portion 120K includes two reflecting mirrors 141a and 141b that reflect a laser beam having passed through the upper part of the other fθ lens 119; and a toroidal lens 142 that allows the laser beam having been reflected off the reflecting mirrors 141a and 141b to converge in the sub scanning direction Y The laser beam having passed through the upper part of the other fθ lens 119 is first, in the black optical portion 120K, reflected off the reflecting mirror 141a diagonally forward and upward, and then, reflected off the reflecting mirror 141b downward in a vertical direction. Thereafter, the laser beam passes through the toroidal lens 142 in a vertical direction and then is outputted from the black light output window 121K.

The magenta optical portion 120M and the cyan optical portion 120C are disposed symmetrical with respect to the polygon mirror 117. The yellow optical portion 120Y and the black optical portion 120K are disposed on the outer side of the magenta optical portion 120M and the cyan optical portion 120C so as to be symmetrical with respect to the polygon mirror 117.

In such a color laser printer 1, in the scanner unit 12, in two laser irradiation optical portions 118 disposed opposite each other with the polygon mirror 117 interposed therebetween, two laser beams emitted from two laser emitting portions 124 that are disposed at right angles to each other and with a space provided therebetween in the sub scanning direction Y, are converted into parallel pencils of rays by two collimating lenses 125, respectively. Thereafter, the laser beams pass through two first slits 130 of the first slit plate 126, respectively, whereby stray light of the laser beams is prevented.

Subsequently, of the two laser beams, one laser beam passes linearly through the reflecting mirror 127, while the other laser beam is reflected off the reflecting mirror 127 at substantially 90° and refracted at substantially right angles. By this, the optical paths of the two laser beams are combined so as to be matched in the main scanning direction X, with a space provided therebetween in the sub scanning direction Y. The two laser beams whose optical paths have been combined pass through two second slits 131 of the second slit plate 128, respectively, which are disposed in parallel in the sub scanning direction Y. At this point, the two laser beams are adjusted in their positions in the sub scanning direction Y.

Hence, even if an error in the sub scanning direction Y occurs in the two laser beams that are matched, by the reflecting mirror 127, in the main scanning direction X, due to the processing accuracy of the reflecting mirror 127 or the position accuracy of a collimating optical system, such an error is adjusted.

Thereafter, the two laser beams having passed through the two second slits 131, respectively, are refracted by a single cylindrical lens 129 so as to converge in the sub scanning direction Y, and then, enter the polygon mirror 117 at different angles. In the two laser beams entering the polygon mirror 117, as described above, error is reduced not only in the main scanning direction X but also in the sub scanning direction Y by means of the two second slits 131 of the second slit plate 128. Therefore, four laser beams entering from the two laser irradiation optical portions 118 can be accurately deflected and scanned by the polygon mirror 117.

Moreover, in each laser irradiation optical portion 118, since the second slits 131 for allowing laser beams to pass therethrough are provided in the same single second slit plate 128, high relative position accuracy between laser beams is achieved, making it possible to ensure accurate relative position between laser beams that enter the polygon mirror 117. Accordingly, in the polygon mirror 117, accurate deflection and scanning can be ensured between laser beams.

Further, the second slit plate 128 is slidably guided in two slide rods 133 of the guide member 132, and positioned by the slide rods 133 and the bottom wall 143. Thus, the second slit plate 128 can be accurately positioned and accordingly the second slits 131 disposed in the second slit plate 128 can be accurately disposed. Hence, more accurate deflection and scanning of laser beams can be achieved.

In the scanner unit 12, in each laser irradiation optical portion 118, the first slit plate 126 is provided between two laser emitting portions 124 and the reflecting mirror 127 such that two first slits 130 are opposite two collimating lenses 125, respectively. The two first slits 130 of the first slit plate 126 limit the cross-sectional shapes of two laser beams, respectively. Hence, it is possible to surely prevent a laser beam emitted from one of the laser emitting portions 124 from interfering with a laser beam emitted from the other laser emitting portion 124. As a result, stray light of laser beams emitted from the two laser emitting portions 124 can be prevented by the two first slits 130 of the first slit plate 126.

In each laser irradiation optical portion 118, two laser emitting portions 124 are disposed as a set. A single second slit plate 128 is provided with respect to the set of two laser emitting portions 124. Two second slits 131 are formed so as to correspond to the two laser emitting portions 124 of a set, respectively. By separating four laser emitting portions 124 into two sets and disposing the two sets of laser emitting portions 124 to two laser irradiation optical portions 118, respectively, accurate deflection and scanning of laser beams can be achieved while ensuring an efficient layout.

In the scanner unit 12, two laser irradiation optical portions 118 are disposed opposite each other so as to be symmetrical with respect to the polygon mirror 117. Specifically, two sets of laser emitting portions 124 (two laser emitting portions 124 are provided as a set in each laser irradiation optical portion 118) are disposed opposite each other so as to be symmetrical with respect to the polygon mirror 117. Two fθ lenses 119 are provided so as to correspond to two laser irradiation optical portions 118, respectively, i.e., two sets of laser beams emitted from two sets of laser emitting portions 124, respectively (each set including two laser emitting portions 124), and to opposite each other with the polygon mirror 117 interposed therebetween, in a direction orthogonal to a direction in which the two sets of laser beams enter the polygon mirror 117. The two sets of laser beams, i.e., four laser beams, having passed through the two fθ lenses 119, respectively, thereafter pass through the yellow optical portion 120Y, the magenta optical portion 120M, the cyan optical portion 120C, and the black optical portion 120K that have optical paths independent of one another. Then, the laser beams are outputted from the yellow light output window 121Y, the magenta light output window 121M, the cyan light output window 121C, and the black light output window 121K, respectively.

By this, two sets of laser beams (four laser beams in total) emitted from the two sets of laser emitting portions 124 (each set including two laser emitting portions 124) disposed symmetrical with respect to the polygon mirror 117 are irradiated onto the polygon mirror 117 from symmetrical directions and deflected and scanned in the main scanning direction X. Thereafter, the two sets of laser beams pass through the two fθ lenses 119, respectively, and are converted into pencils of rays of uniform velocity on an image surface. Then, the four laser beams of two sets are outputted from different light output windows 121 by the laser output optical portions 120. Accordingly, while the scanner unit 12 can be configured with a small space, four laser beams that are accurately deflected and scanned can be outputted from different light output windows 121.

In the color laser printer 1, four process portions 13 are provided so as to correspond to the laser beams outputted from the four light output windows 121 of the aforementioned scanner unit 12. By irradiating laser beams independent of one another onto four photosensitive drums 71 provided to the process portions 13, respectively, electrostatic latent images are formed. Then, the four electrostatic latent images formed on the four photosensitive drums 71 are developed by four development rollers 76 provided to the process portions 13, using developers of yellow, magenta, cyan, and black colors. Thereafter, in the transfer portion 14, the color images are sequentially superposed onto the same single sheet of paper 3. Accordingly, in the laser printer 1, while accurate electrostatic latent images are formed on the photosensitive drums 71, respectively, and an accurate color image can be formed, a color image can be formed at substantially the same speed as that for a monochrome image.

In the above description, two second slits 131 formed in the second slit plate 128 may have the same aperture shape and aperture area, or may be changed as appropriate, depending on the type of the laser emitting portions 124 or the color to be developed. In addition, the space in the sub scanning direction Y provided between the two second slits 131 can be determined as appropriate, depending on the type of the laser emitting portions 124 or the color to be developed.

Although, in the above description, two laser irradiation optical portions 118, each including a set of two laser emitting portions 124, are symmetrically disposed with respect to the polygon mirror 117, the disposition of the laser emitting portions 124 or the like is not particularly limited; for example, a single laser irradiation optical portion 118 that includes a set of four laser emitting portions 124 may be disposed on one side with respect to the polygon mirror 117. In such disposition, in the second slit plate 128, four second slits 131 are bored in parallel and with a space provided therebetween in the sub scanning direction Y.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. An optical scanning device comprising:
a first holding member including: a first holding portion that holds a first laser emitting portion that emits a first laser beam; and a first-screw inserting portion that allows a first screw to be inserted thereinto;
a second holding member including: a second holding portion that holds a second laser emitting portion that emits a second laser beam; and a second-screw inserting portion that allows a second screw to be inserted thereinto;
a base member including: a first-lens supporting portion that supports a first lens through which the first laser beam passes; a second-lens supporting portion that supports a second lens through which the second laser beam passes; a first-screw inserting and fixing portion that allows the first screw inserted into the first-screw inserting portion to be inserted thereinto for fixation; and a second-screw inserting and fixing portion that allows the second screw inserted into the second-screw inserting portion to be inserted thereinto for fixation; and
a light deflecting unit that deflects and scans the first laser beam and the second laser beam in a main scanning direction.

2. The optical scanning device according to claim 1, wherein the first holding member, the second holding member, and the base member are continuously formed.

3. The optical scanning device according to claim 2, wherein the first holding member, the second holding member, and the base member are formed by bending a sheet metal.

4. The optical scanning device according to claim 1, wherein
the first-screw inserting portion and the first-screw inserting and fixing portion are disposed with a space provided therebetween, and the first holding member and the first-lens supporting portion are disposed with a space provided therebetween in a direction in which the first-screw inserting portion and the first-screw inserting and fixing portion are opposite each other,
the space between the first holding member and the first-lens supporting portion is adjusted by screwing the first screw forward or backward against the first-screw inserting and fixing portion,
the second-screw inserting portion and the second-screw inserting and fixing portion are disposed with a space provided therebetween, and the second holding member and the second-lens supporting portion are disposed with a space provided therebetween in a direction in which the second-screw inserting portion and the second-screw inserting and fixing portion are opposite each other, and
the space between the second holding member and the second-lens supporting portion is adjusted by screwing the second screw forward or backward against the second-screw inserting and fixing portion.

5. The optical scanning device according to claim 1, wherein the first-lens supporting portion and the second-lens supporting portion are disposed at different locations in a sub scanning direction,
the optical scanning device further comprising a light reflecting unit that reflects at least one of the first laser beam having passed through the first-lens supporting portion and the second laser beam having passed through the second-lens supporting portion, and then allows a relative position, in the main scanning direction, between the first laser beam and the second laser beam to be matched.

6. The optical scanning device according to claim 5, further comprising a slit member having a slit bored therein at a location between the first-lens supporting portion and the light reflecting unit in an optical path of the first laser beam, and at a location between the second-lens supporting portion and the light reflecting unit in an optical path of the second laser beam.

7. The optical scanning device according to claim 6, further comprising a positioning unit that positions the light reflecting unit, wherein
the slit member is integrally formed with the positioning unit.

8. The optical scanning device according to claim 1, wherein in the base member a step portion in a sub scanning direction is provided between the first-lens supporting portion and the second-lens supporting portion.

9. The optical scanning device according to claim 1, wherein the first holding member and the second holding member are disposed at substantially right angles to each other.

10. The optical scanning device according to claim 1, wherein
the base member includes a supporting member by which the first-screw inserting and fixing portion and the second-screw inserting and fixing portion are supported, and
the first-screw inserting and fixing portion and the second-screw inserting and fixing portion are formed by being bent in directions opposite to each other with respect to the supporting member.

11. The optical scanning device according to claim 1, wherein
a plurality of optical elements are provided, each optical element including, as a set, the first holding member, the second holding member, and the base member,
the light deflecting unit has a plurality of deflecting surfaces, and
the first laser beams and the second laser beams emitted from different optical elements are irradiated onto different deflecting surfaces of the light deflecting unit.

12. The optical scanning device according to claim 11, wherein two optical elements are provided.

13. The optical scanning device according to claim 12, wherein the optical elements are disposed such that the first laser beam and the second laser beam emitted from one of the optical elements and the first laser beam and the second laser beam emitted from other one of the optical elements enter the light deflecting unit in parallel.

14. An image forming apparatus comprising:
the optical scanning device according to claim 1; and
a plurality of photosensitive bodies which are provided for laser beams, respectively, which include the first laser beam and the second laser beam, and onto which the laser beams are irradiated and thereby electrostatic latent images are formed, respectively, the first laser beam and the second laser beam being scanned in the main scanning direction by the light deflecting unit.

15. An image forming apparatus comprising:
the optical scanning device according to claim 12; and
four photosensitive bodies which are provided for laser beams, respectively, which include two sets of first laser beams and second laser beams, and onto which the laser beams are irradiated and thereby electrostatic latent images are formed, respectively, the first laser beams and the second laser beams being scanned in the main scanning direction by the light deflecting unit, wherein
the electrostatic latent images formed on the photosensitive bodies are developed in different colors.

16. An optical scanning device comprising:
a plurality of laser emitting portions that emit laser beams;
a light deflecting unit that deflects and scans, in a main scanning direction, the laser beams emitted from the laser emitting portions;
an optical path combining unit disposed in a passing direction of a laser beam and between the laser emitting portions and the light deflecting unit, and allowing the laser beams emitted from the laser emitting portions to be matched in the main scanning direction; and
a slit member disposed in the passing direction of a laser beam and between the optical path combining unit and the light deflecting unit, and having diaphragm apertures disposed therein in parallel and in a sub scanning direction, the diaphragm apertures being formed so as to correspond to the laser beams emitted from the laser emitting portions.

17. The optical scanning device according to claim 16, further comprising a guide member that slidably guides the slit member, thereby positioning the slit member.

18. The optical scanning device according to claim 16, further comprising a stray-light preventing unit for preventing stray light of the laser beams emitted from the laser emitting portions, the stray-light preventing unit being provided so as to correspond to the laser emitting portions and being disposed in the passing direction of a laser beam and between the laser emitting portions and the optical path combining unit.

19. The optical scanning device according to claim 18, wherein the stray-light preventing unit limits a cross-sectional shape of laser beams traveling toward the optical path combining unit.

20. The optical scanning device according to claim 16, wherein
a plurality of the laser emitting portions are disposed as a set,
a single slit member is provided with respect to each set of laser emitting portions, and
the diaphragm apertures are formed so as to be suitable for each set of the laser emitting portions.

21. The optical scanning device according to claim 16, wherein the laser emitting portions, two as a set, are disposed symmetrical with respect to the light deflecting unit,
the optical scanning device further comprising:
two fθ lenses provided so as to correspond to sets of laser beams, respectively, that are emitted from sets of the laser emitting portions and deflected and scanned by the light deflecting unit, the fθ lenses converting the sets of laser beams into pencils of rays of uniform velocity on an image surface; and
an optical path forming unit that allows the laser beams having passed through the fθ lenses to be outputted from different locations.

22. An image forming apparatus comprising:
the optical scanning device according to claim 16; and
a plurality of photosensitive bodies onto which a plurality of laser beams deflected and scanned in the main scanning direction by the light deflecting unit are irradiated and thereby electrostatic latent images are formed, respectively.

23. An image forming apparatus comprising:
a plurality of laser emitting portions that emit laser beams;
a light deflecting unit that deflects and scans, in a main scanning direction, the laser beams emitted from the laser emitting portions;
an optical path combining unit disposed in a passing direction of a laser beam and between the laser emitting portions and the light deflecting unit, and allowing the laser beams emitted from the laser emitting portions to be matched in the main scanning direction;
a slit member disposed in the passing direction of a laser beam and between the optical path combining unit and the light deflecting unit, and having diaphragm apertures disposed therein in parallel and in a sub scanning direction, the diaphragm apertures being formed so as to correspond to the laser beams emitted from the laser emitting portions; and
a plurality of photosensitive bodies onto which the laser beams deflected and scanned in the main scanning direction by the light deflecting unit are irradiated and thereby electrostatic latent images are formed, respectively.

24. The image forming apparatus according to claim 23, wherein four photosensitive bodies are provided,
the image forming apparatus further comprising four developer supplying units that are provided for the photosensitive bodies, respectively, and that supply developers of different colors to the photosensitive bodies, respectively.
